(19) United States
(12) Patent Application Publication
(10) Pub. No.: US 2026/0000985 A1
(43) Pub. Date: Jan. 1, 2026

(54) VIRTUAL OBJECT INTERACTION

(71) Applicant: Tencent Technology (Shenzhen) Company Limited, Shenzhen (CN)

(72) Inventor: Zezhi ZHANG, Shenzhen (CN)

(73) Assignee: Tencent Technology (Shenzhen) Company Limited, Shenzhen (CN)

(21) Appl. No.: 19/319,659

(22) Filed: Sep. 4, 2025

Related U.S. Application Data
(63) Continuation of application No. PCT/CN2024/105402, filed on Jul. 15, 2024.

(30) Foreign Application Priority Data
Aug. 21, 2023 (CN) 202311058272.2

(51) Int. Cl. A63F 13/55; A63F 13/48; A63F 13/837

(52) U.S. Cl. CPC A63F 13/55; A63F 13/48; A63F 13/837

(57) ABSTRACT

In a virtual object interaction method for a game application, in response to starting a target game match, identity information assigned to a first virtual object in the target game match is output for display. Each of the plurality of virtual objects is divided into one of a first faction and a second faction. The first faction includes a first subset of the plurality of virtual objects having first identity information and a second subset of the plurality of virtual objects having second identity information. The second faction includes a third subset of the plurality of virtual objects having third identity information. The first virtual object is controlled to initiate an interaction with a second virtual object. An interaction result that is based on the interaction, the identity information of the first virtual object, and the identity information of the second virtual object is output for display.

### RELATED APPLICATIONS

The present application is a continuation of International Application No. PCT/CN2024/105402, filed on Jul. 15, 2024, which claims priority to Chinese Patent Application No. 202311058272.2, filed on Aug. 21, 2023. The entire disclosure of the prior applications are hereby incorporated by reference.

### FIELD OF THE TECHNOLOGY

This application relates to the field of Internet technologies, including virtual object interaction.

### BACKGROUND OF THE DISCLOSURE

With the advancement of Internet and video gaming technologies, games have become one of the primary forms of entertainment, and faction-based games have sparked a wave of popularity. In a faction-based game, players form opposing factions to compete and determine a winner. This process not only cultivates team collaboration skills but also allows the players to enjoy the fun of the game.

Currently, in a faction-based game, players are assigned various identities for multi-faction strategic competition. Taking the game “Werewolf” as an example, multiple players are divided into two factions: one is the “villagers (good)” faction, and the other is the “werewolves” faction. The core gameplay revolves around identity deduction among the players.

However, the inventor has identified at least the following issues in current versions: Based on the core gameplay, players primarily rely on verbal communication to form logical chains to rigorously deduce the identities of other players, resulting in relatively slow-paced gameplay and a lack of tension and excitement. In addition, the gameplay overemphasizes logic, creating an entry barrier, thereby reducing the accessibility and mass appeal of the gameplay. To date, no effective solutions have been proposed to address these issues.

### SUMMARY

Aspects of this disclosure provide a virtual object interaction method, a virtual object interaction apparatus, and a non-transitory computer-readable storage medium. This disclosure provides a competitive gameplay mechanism combining identity deduction with real-time combat, which not only lowers the entry barrier to a game but also can balance the strategic depth of the game with the immersion of the gameplay mechanism. Examples of technical solutions of this disclosure may be implemented as follows:

An aspect of this disclosure provides a virtual object interaction method for a game application. In the method, in response to starting a target game match, identity information assigned to a first virtual object of a plurality of virtual objects in the target game match is output for display. The first virtual object is controlled by a player. Each of the plurality of virtual objects is divided into one of a first faction and a second faction. The first faction includes a first subset of the plurality of virtual objects having first identity information and a second subset of the plurality of virtual objects having second identity information. The second faction includes a third subset of the plurality of virtual objects having third identity information. The first virtual object is controlled to initiate an interaction with a second virtual object of the plurality of virtual objects. An interaction result that is based on the interaction, the identity information of the first virtual object, and the identity information of the second virtual object is output for display.

An aspect of this disclosure provides a virtual object interaction apparatus for a game application. The apparatus includes processing circuitry configured to output for display, in response to starting a target game match, identity information assigned to a first virtual object of a plurality of virtual objects in the target game match. The first virtual object is controlled by a player. Each of the plurality of virtual objects is divided into one of a first faction and a second faction. The first faction includes a first subset of the plurality of virtual objects having first identity information and a second subset of the plurality of virtual objects having second identity information. The second faction includes a third subset of the plurality of virtual objects having third identity information. The processing circuitry is configured to control the first virtual object to initiate an interaction with a second virtual object of the plurality of virtual objects. The processing circuitry is configured to output for display an interaction result that is based on the interaction, the identity information of the first virtual object, and the identity information of the second virtual object.

An aspect of this disclosure provides a virtual object interaction method, the interaction method being applied to a target game application including a plurality of virtual objects, the plurality of virtual objects being at least divided into a first faction and a second faction, the first faction including at least one virtual object having first identity information and at least one virtual object having second identity information, identity information of each virtual object from the first faction being in a non-public state, the second faction including at least one virtual object having target identity information, and the interaction method including: displaying, in response to a start operation on a target game match, identity information randomly assigned to a first virtual object, the identity information being the first identity information, the second identity information, or the target identity information, and the first virtual object being one of the plurality of virtual objects; controlling the first virtual object to initiate a target interaction event with a second virtual object, the second virtual object being another one of the plurality of virtual objects other than the first virtual object; and displaying an interaction event result corresponding to the target interaction event in a case that response to the target interaction event is successful, where the interaction event result has an association relationship with the identity information of the first virtual object and identity information of the second virtual object.

An aspect of this disclosure provides a virtual object interaction apparatus, the virtual object interaction apparatus being used in a target game application including a plurality of virtual objects, the plurality of virtual objects being at least divided into a first faction and a second faction, the first faction including at least one virtual object having first identity information and at least one virtual object having second identity information, identity information of each virtual object from the first faction being in a non-public state, the second faction including at least one virtual object having target identity information, and the virtual object interaction apparatus including: a display module, configured to display, in response to a start operation on a target game match, identity information randomly assigned to a first virtual object, the identity information being the first identity information, the second identity information, or the target identity information, and the first virtual object being one of the plurality of virtual objects; and a control module, configured to control the first virtual object to initiate a target interaction event with a second virtual object, the second virtual object being another one of the plurality of virtual objects other than the first virtual object, where the display module is further configured to display an interaction event result corresponding to the target interaction event in a case that response to the target interaction event is successful, where the interaction event result has an association relationship with the identity information of the first virtual object and identity information of the second virtual object.

Another aspect of this disclosure provides a computer device, including a memory and a processor, the memory having a computer program stored therein, and the processor, when executing the computer program, implementing the methods in the foregoing aspects.

An aspect of this disclosure further provides a non-transitory computer-readable storage medium, having computer-executable instructions stored therein, the computer-executable instructions, when executed by a processor, cause the processor to implement the methods in the foregoing aspects.

Another aspect of this disclosure provides a computer program product, including a computer program, and the computer program, when executed by a processor, implementing the methods in the foregoing aspects.

It may be learned from the foregoing technical solutions that the aspects of this disclosure have the following advantages:

Aspects of this disclosure provide a virtual object interaction method. In the method, a plurality of virtual objects are at least divided into a first faction and a second faction, the first faction includes at least one virtual object having first identity information and at least one virtual object having second identity information, identity information of each virtual object from the first faction is in a non-public state, and the second faction includes at least one virtual object having target identity information. Based on this, first, identity information randomly assigned to a first virtual object is displayed in response to a start operation on a target game match. Next, the first virtual object is controlled to initiate a target interaction event with a second virtual object. An interaction event result corresponding to the target interaction event is displayed in a case that response to the target interaction event is successful, where the interaction event result has an association relationship with the identity information of the first virtual object and identity information of the second virtual object. In the foregoing manner, after starting a game match, a player may learn identity information randomly assigned to the player, and determine, based on the identity information, a faction to which the player belongs. In a process of competition between two factions, a player belonging to a first faction needs to deduce identity information assigned to other players, and the player may further control a virtual object to interact with other virtual objects. Therefore, this disclosure provides a competitive gameplay mechanism combining identity deduction with real-time combat, which not only lowers the entry barrier to a game but also can balance the strategic depth of the game with the immersion of the gameplay mechanism. In addition, the player can be effectively guided to make an interaction decision by using displayed identity information and displaying an interaction event result after a target interaction event is initiated, thereby reducing unnecessary interaction, and improving interaction efficiency and the utilization of interaction resources.

### BRIEF DESCRIPTION OF THE DRAWINGS

FIG. 1 is a schematic diagram of an implementation environment of a virtual object interaction method according to an aspect of this disclosure.

FIG. 2 is a schematic diagram of a duration relationship based on different stages of a target game application according to an aspect of this disclosure.

FIG. 3 is a schematic flowchart of an implementation environment of a virtual object interaction method according to an aspect of this disclosure.

FIG. 4 is a schematic flowchart based on different stages of a target game application according to an aspect of this disclosure.

FIG. 5 is a schematic diagram of a first virtual object rescuing a second virtual object according to an aspect of this disclosure.

FIG. 6 is a schematic diagram of loading a first progress bar according to an aspect of this disclosure.

FIG. 7 is another schematic diagram of loading a first progress bar according to an aspect of this disclosure.

FIG. 8 is a schematic diagram of automatically releasing a trapped state of a first virtual object according to an aspect of this disclosure.

FIG. 9 is a schematic diagram of a second virtual object rescuing a first virtual object according to an aspect of this disclosure.

FIG. 10 is a schematic diagram of a first virtual object initiating an attack operation on a second virtual object according to an aspect of this disclosure.

FIG. 11 is a schematic diagram of a first virtual object performing a ranged attack according to an aspect of this disclosure.

FIG. 12 is a schematic diagram of displaying a first match settlement result according to an aspect of this disclosure.

FIG. 13 is a schematic diagram of updating current quantity of surviving objects according to an aspect of this disclosure.

FIG. 14 is another schematic diagram of a first virtual object initiating an attack operation on a second virtual object according to an aspect of this disclosure.

FIG. 15 is another schematic diagram of a first virtual object performing a ranged attack according to an aspect of this disclosure.

FIG. 16 is a schematic diagram of a first virtual object performing a melee attack according to an aspect of this disclosure.

FIG. 17 is a schematic diagram of displaying a second match settlement result according to an aspect of this disclosure.

FIG. 18 is a schematic diagram of a first virtual object switching identity information according to an aspect of this disclosure.

FIG. 19 is a schematic diagram of disclosing identity information to a second faction according to an aspect of this disclosure.

FIG. 20 is a schematic diagram of a first virtual object placing a trap prop according to an aspect of this disclosure.

FIG. 21 is a schematic diagram of picking up a virtual resource according to an aspect of this disclosure.

FIG. 22 is a schematic diagram of providing a corresponding award based on a resource type according to an aspect of this disclosure.

FIG. 23 is a schematic diagram of updating a virtual resource in a virtual scene according to an aspect of this disclosure.

FIG. 24 is a schematic diagram of a scene map constructed based on a virtual scene according to an aspect of this disclosure.

FIG. 25 is a schematic diagram of a user operation interface according to an aspect of this disclosure.

FIG. 26 is a schematic diagram of a virtual object interaction apparatus according to an aspect of this disclosure.

FIG. 27 is a schematic structural diagram of a computer device according to an aspect of this disclosure.

### DETAILED DESCRIPTION

Aspects of this disclosure provide a virtual object interaction method, a related apparatus, a device, and a storage medium. This disclosure provides a competitive gameplay mechanism combining identity deduction with real-time combat, which not only lowers the entry barrier to a game but also can balance the strategic depth of the game with the immersion of the gameplay mechanism. Further, the descriptions of the terms are provided as examples only and are not intended to limit the scope of the disclosure.

The terms such as “first”, “second”, “third”, and “fourth” (if any) in the specification and claims of this disclosure and in the accompanying drawings are used for distinguishing similar objects and not necessarily used for describing any particular order or sequence. Data used in this way is exchangeable in a proper case, so that the aspects of this disclosure described herein can be implemented in an order different from the order shown or described herein. In addition, the terms “include”, “correspond to” and any other variants are intended to cover a non-exclusive inclusion. For example, a process, method, system, product or device that includes a series of steps or units not only includes those steps or units specified expressly, but also includes other steps or units that are not specified expressly or are inherent to the process, method, product or device.

Faction-based game events are typically categorized into online and offline formats. Online events usually utilize multiplayer online gaming platforms for matches, while offline events involve organizers providing venues and equipment for on-site competition. In both online and offline matches, players need to form their factions and select corresponding game modes for competition.

In one category of faction-based games, players are assigned various identities for multi-faction strategic competition. Typically, multiple players are divided into two factions: one is the “villagers (good)” faction, and the other is the “werewolves” faction. The core gameplay revolves around identity deduction among the players. Players primarily rely on verbal communication to form logical chains to rigorously deduce the identities of other players, resulting in relatively slow-paced gameplay and a lack of tension and excitement. The game experience emphasizes a slow pace, verbal communication, and logic. Therefore, an entry barrier is created, thereby reducing the accessibility and mass appeal of the gameplay among players.

In another category of faction-based games, players are divided into two or more factions in various forms engaging in symmetrical offense and defense or asymmetrical pursuits/attacks. In such gameplay, players typically have various real-time combat capabilities—both offensive and defensive—with a design focus on combat operations and tactics. Actual gameplay largely revolves around only operations, resulting in relatively shallow gameplay depth and relatively monotonous excitement.

Based on this, this disclosure provides a multiplayer competitive gameplay mechanism combining identity deduction with real-time combat elements. Players are assigned different identity information, and capabilities of players having different identities are also different. For example, a virtual object having first identity information (for example, a “guard” identity) and a virtual object having target identity information (for example, a “killer” identity) both have a melee attack capability or a ranged attack capability. During real-time combat, in an attack-counterattack, pursuit-evasion, or another process, the gameplay naturally possesses tension and excitement. A virtual object having second identity information (for example, a “doll” identity) does not have an attack capability. Meanwhile, players from a first faction (for example, a “good” faction) do not know identity information of all players, and need to gradually find out the identities of other players carefully during a gaming process and avoid attacks. Therefore, a strong strategic element of identity deduction is brought to the gameplay. The virtual object interaction method provided in this disclosure, when applied, includes at least one of the following scenarios.

### I. Asymmetric Factions.

With reference to the solution provided in this disclosure, for example, it is assumed that each game match requires exactly 10 players to participate, and each player controls one virtual object. After entering a game match, players are randomly assigned identity information. For example, two players are “killers”, two players are “guards”, and six players are “dolls”. Players having the “killer” identity belong to one faction (for example, an “evil” faction), and players having the “guard” identity or “doll” identity belong to another faction (for example, a “good” faction). It can be learned that the quantities of players of the two factions are not equal. In this case, the competition takes place between asymmetric factions.

In a process of the competition between the two factions, the objective of the players from the “evil” faction is to eliminate all players having the “guard” identity and the “doll” identity within the game time. The objective of the players from the “evil” faction is to eliminate all players having the “killer” identity or survive to the end of the game time.

### II. Symmetric Factions.

With reference to the solution provided in this disclosure, for example, it is assumed that each game match requires exactly 10 players to participate, and each player controls one virtual object. After entering a game match, players are randomly assigned identity information. For example, five players are “killers”, two players are “guards”, and three players are “dolls”. Players having the “killer” identity belong to one faction (for example, an “evil” faction), and players having the “guard” identity or “doll” identity belong to another faction (for example, a “good” faction). It can be learned that the quantities of players of the two factions are equal. In this case, the competition takes place between symmetric factions.

In a process of the competition between the two factions, players from the “good” faction may be revived once by using a resurrection prop. If a player from the “good” faction has no resurrection prop, the player is directly eliminated after being killed by a player having the “killer” identity.

### III. Custom Factions.

With reference to the solution provided in this disclosure, for example, it is assumed that each game match requires exactly 10 players to participate, and each player controls one virtual object. Before entering a game match, players may select faction types. For example, in a “faction type A”, one player has the “killer” identity, two players have the “guard” identity, and seven players have the “doll” identity. In a “faction type B”, two players have the “killer” identity, two players have the “guard” identity, and six players have the “doll” identity. In a “faction type C”, five players have the “killer” identity, two players have the “guard” identity, and three players have the “doll” identity. After selecting a faction type, players are matched into the same game match with other players who select the same faction type. After entering the game match, a player is randomly assigned identity information, and the player competes according to the identity information.

The foregoing application scenarios are merely examples, and the virtual object interaction method provided in this aspect may be further applied to other scenarios. This is not limited herein.

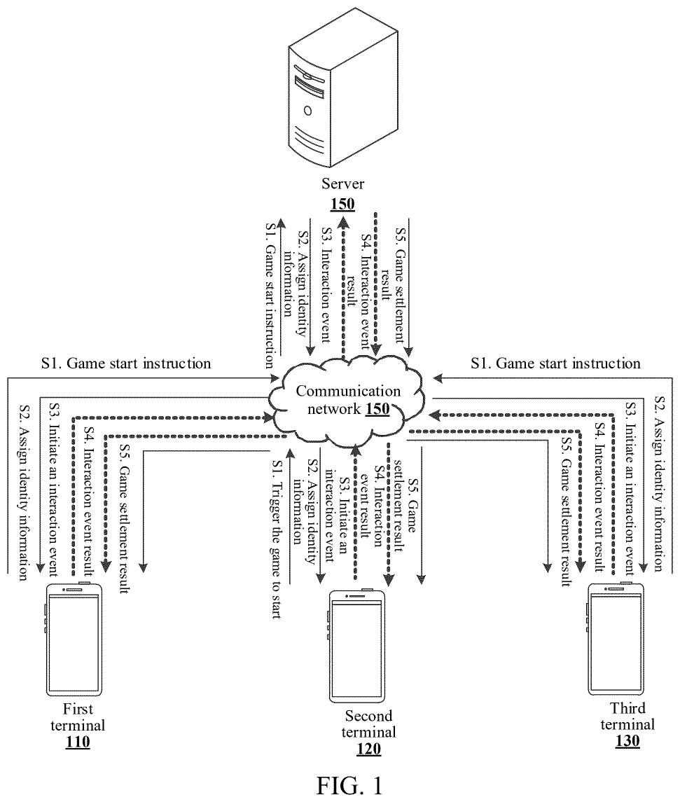

The method provided in this disclosure may be applied to an implementation environment shown in FIG. 1. The implementation environment includes a first terminal 110, a second terminal 120, a third terminal 130, and a server 140. The terminals may communicate with the server 140 through a communication network 140. The communication network 140 uses standard communication technologies and/or protocols, and is usually the Internet, or may alternatively be any other network, including but not limited to, Bluetooth, a local area network (LAN), a metropolitan area network (MAN), a wide area network (WAN), or any combination of a mobile network, a dedicated network, or a virtual dedicated network. In some aspects, custom or private data communication techniques may be used instead of or in addition to the foregoing data communication techniques.

The terminal of this disclosure includes, but is not limited to, a mobile phone, a tablet computer, a notebook computer, a desktop computer, a smart voice interaction device, a virtual reality device, a smart home appliance, an in-vehicle terminal, and an aircraft. A client is deployed on the terminal. The client may run on the terminal 110 in the form of a browser, or may run on the terminal 110 in the form of an independent application (APP). For example, the first terminal 110, the second terminal 120, and the third terminal 130 are respectively terminals used by players having different identity information, and more terminals may be further included during actual application.

The server 140 of this disclosure may be an independent physical server, or may be a server cluster formed by a plurality of physical servers or a distributed system, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence (AI) platform.

With reference to the foregoing implementation environment, in operation S1, the first terminal 110, the second terminal 120, and the third terminal 120 respectively transmit game start instructions to the server 140 through the communication network 150. In operation S2, the server 140 randomly assigns identity information to each player according to the game start instructions triggered by the players, and transmits the corresponding identity information of the players to the terminals respectively through the communication network 150.

In operation S3, a player may trigger an interaction event (for example, an attack) by using a terminal, and feed back the interaction event to the server 140 through the communication network 150. For example, a player launches, by using the first terminal 110, an attack to a virtual object controlled by another player. The player may alternatively choose not to trigger any interaction event during a game match. In operation S4, the server 140 generates a corresponding interaction event result according to the interaction event and the identity information corresponding to the players, and transmits the interaction event result to the corresponding terminals through the communication network 150. In operation S5, when the game match ends, the server 140 transmits a match settlement result of a current round of game to the terminals through the communication network 150.

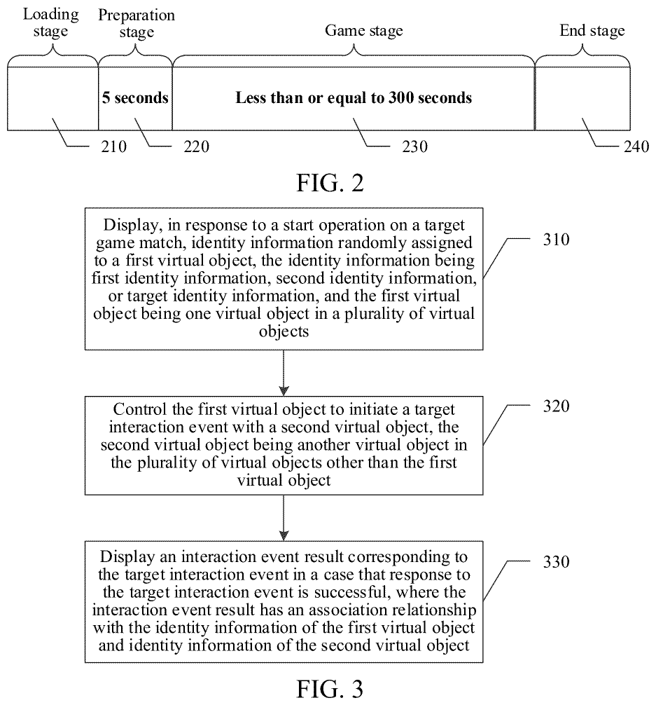

Based on the implementation scenario shown in FIG. 1, for ease of understanding, FIG. 2 is a schematic diagram of a duration relationship based on different stages of a target game application according to an aspect of this disclosure. As shown in the figure, 210 indicates a loading stage, 220 indicates a preparation stage, 230 indicates a game stage, and 240 indicates an end stage. The stages are respectively described below.

Loading stage: Before entering a game match, a player needs to enter a loading stage first. The loading stage is configured for loading a virtual scene in a game and waiting for all players to join. The game starts as soon as all the players have completed loading.

Preparation stage: After completing loading, all the players first enter a preparation stage. The preparation stage has a fixed time length, for example, may be set to 5 seconds. In the preparation stage, a system randomly assigns identity information and a birth point position to each player. In this stage, each player can see identity information of the player in a current round of game, but temporarily cannot perform operations such as moving.

Game stage: After the preparation stage ends, all the players can operate respective objects to formally start the game. To achieve victory objectives, players from different factions may perform various actions such as moving, competing, and pursuing in the scene. It is assumed that the game stage lasts 300 seconds at most. Based on this, in an actual gaming process, due to the presence of a virtual prop that reduces game duration, the game time has a dynamic value (i.e., less than or equal to 300 seconds).

End stage: When the game time ends or one faction achieves victory conditions, the game ends automatically. In the end stage, information such as a match outcome and player points are displayed.

With reference to the foregoing introduction, the virtual object interaction method of this disclosure is described below in further detail. Referring to FIG. 3, the virtual object interaction method in the aspects of this disclosure may be completed independently by a terminal, or may be completed independently by a server, or may be completed collaboratively by a terminal and a server. This disclosure is applied to a target game application including a plurality of virtual objects. The plurality of virtual objects are at least divided into a first faction and a second faction. The first faction includes at least one virtual object having first identity information and at least one virtual object having second identity information. Identity information of each virtual object from the first faction is in a non-public state. The second faction includes at least one virtual object having target identity information. This disclosure includes the following operations:

310. Display, in response to a start operation on a target game match, identity information randomly assigned to a first virtual object, the identity information being the first identity information, the second identity information, or the target identity information, and the first virtual object being one of the plurality of virtual objects. For example, in response to starting a target game match, identity information assigned to a first virtual object of a plurality of virtual objects in the target game match is output for display. The first virtual object is controlled by a player. Each of the plurality of virtual objects is divided into one of a first faction and a second faction. The first faction includes a first subset of the plurality of virtual objects having first identity information and a second subset of the plurality of virtual objects having second identity information. The second faction includes a third subset of the plurality of virtual objects having third identity information.

In one or more aspects, the target game match supports at least three players to join, and each player controls one virtual object. Based on this, each virtual object is randomly assigned one piece of identity information. The identity information indicates a specific role type played by the player after the player enters the game, and the identity determines capabilities possessed by the virtual object.

For example, a “first virtual object” controlled by a player is used as an example for description in this disclosure. Based on this, when the target game match starts, the identity information of the first virtual object is displayed, and the identity information is the first identity information, the second identity information, or the target identity information. The first identity information may be a “guard” identity, the second identity information may be a “doll” identity, and the target identity information may be a “killer” identity. Players having the first identity information or the second identity information belong to the same faction, and players having the target identity information belong to another faction. In a competitive game, factions represent groups that compete with each other, each faction may include players having at least one identity, and the factions determine cooperative and competitive relationships between the included players and determining of victory and defeat conditions.

A player may use a game account to log in to the target game application running on a client, and control the first virtual object in the target game match. A corresponding game picture is displayed on a terminal on which a client running a target game application is located. Under the third-person perspective, the game picture displays the first virtual object controlled by the player. Under the first-person perspective, the game picture may not display the first virtual object controlled by the player.

A representation manner of the target game application in this disclosure includes, but is not limited to, a two-dimensional (2D) form, a three-dimensional (3D) form, a virtual reality (VR) form, an augmented reality (AR) form, and a mixed reality (MR) form.

“In response to” in this disclosure indicates a condition or status on which the execution of an operation depends. When a condition or status is met, one or more operations may be performed. These operations may be performed in real time or may be performed after a delay.

320. Control the first virtual object to initiate a target interaction event with a second virtual object, the second virtual object being another one of the plurality of virtual objects other than the first virtual object. For example, the first virtual object is controlled to initiate an interaction with a second virtual object of the plurality of virtual objects.

In one or more aspects, the player may control the first virtual object to initiate the target interaction event with the second virtual object. For example, the first virtual object interacts with the second virtual object to trigger the target interaction event. The target interaction event includes, but is not limited to, a rescue, a ranged attack, and a melee attack.

330. Display an interaction event result corresponding to the target interaction event in a case that response to the target interaction event is successful, where the interaction event result has an association relationship with the identity information of the first virtual object and identity information of the second virtual object. For example, a virtual object having the first identity information has a running capability, a jump capability, an attack capability, and a rescue capability. A virtual object having the second identity information has a running capability, a jump capability, and a rescue capability, but does not have an attack capability. A virtual object having the target identity information has a running capability, a jump capability, an attack capability, and a trap placement capability. For example, an interaction result that is based on the interaction, the identity information of the first virtual object, and the identity information of the second virtual object is output for display.

In one or more aspects, the interaction event result corresponding to the target interaction event is displayed in a case that the response to the target interaction event is successful. The interaction event result is not only related to the target interaction event, but also related to the identity information of the first virtual object and the identity information of the second virtual object. For example, if the first virtual object and the second virtual object belong to the same faction and the target interaction event is an “attack”, the interaction event result is that the first virtual object accidentally harms the second virtual object, and consequently, a player controlling the second virtual object is eliminated.

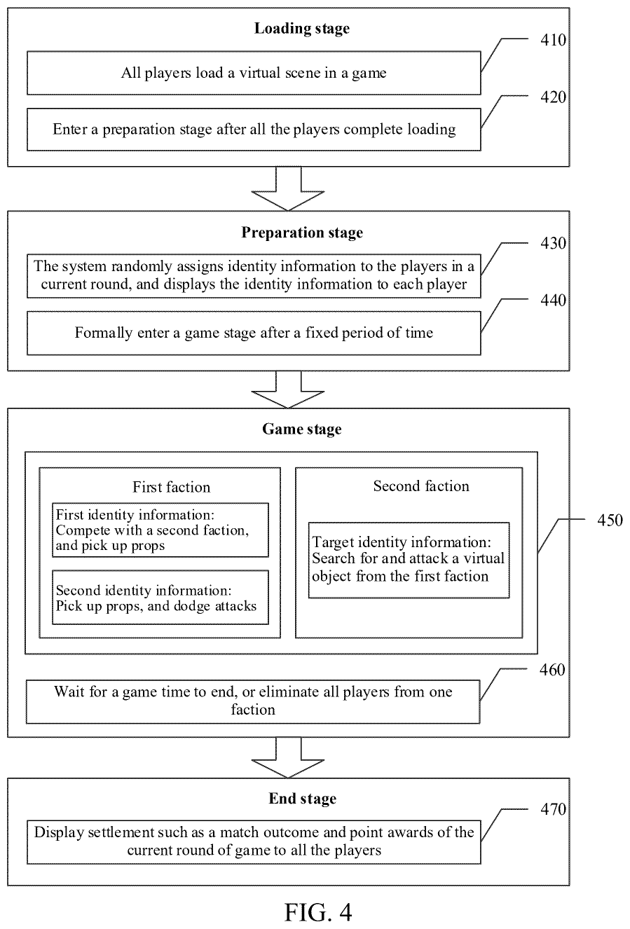

For example, for ease of understanding, FIG. 4 is a schematic flowchart based on different stages of a target game application according to an aspect of this disclosure. As shown in the figure, the procedure includes the following operations.

In operation 410, all players participating in a target game match load a virtual scene in a game.

In operation 420, after all the players complete loading, a preparation stage is entered.

In operation 430, the system randomly assigns identity information to the players in a current round, and displays the identity information to the corresponding players separately.

In operation 440, a game stage is formally entered after a fixed period of time (for example, 5 seconds).

In operation 450, after the game stage is entered, a player having first identity information may control a virtual object to pick up a prop and compete with a virtual object from a second faction. A player having second identity information may control a virtual object to pick up a prop and dodge an attack. A player having the target identity information searches for and attacks a virtual object from the first faction.

In operation 460, wait for a game time to end, or eliminate all players from one faction.

In operation 470, settlement results such as a match outcome and point awards of the current round of game are displayed to all the players.

Aspects of this disclosure provide a virtual object interaction method. In the foregoing manner, after starting a game match, a player may learn identity information randomly assigned to the player, and determine, based on the identity information, a faction to which the player belongs. In a process of competition between two factions, a player belonging to a first faction needs to deduce identity information assigned to other players, and the player may further control a virtual object to interact with other virtual objects. Therefore, this disclosure provides a competitive gameplay mechanism combining identity deduction with real-time combat, which not only lowers the entry barrier to a game but also can balance the strategic depth of the game with the immersion of the gameplay mechanism.

In some aspects, based on the foregoing one or more aspects corresponding to FIG. 3, in another aspect provided in the aspects of this disclosure, the identity information of the first virtual object is the first identity information or the second identity information, and the identity information of the second virtual object is the first identity information or the second identity information.

The controlling the first virtual object to initiate a target interaction event with a second virtual object may include:
controlling, when the second virtual object is in an immobilized state, the first virtual object to initiate a rescue operation on the second virtual object, and displaying a first progress bar, where the first progress bar indicates the progress of releasing the immobilized state of the second virtual object; and
the displaying an interaction event result corresponding to the target interaction event in a case that response to the target interaction event is successful may include:
determining that the response to the target interaction event is successful in a case that loading of the first progress bar is completed, and displaying the second virtual object with the immobilized state released.

In one or more aspects, a manner of rescuing another virtual object is described. It can be known from the foregoing aspect that a virtual object (for example, the second virtual object) having the first identity information (for example, the “guard” identity) or the second identity information (for example, the “doll” identity) may be trapped in a trap and therefore is in an immobilized state. Therefore, another virtual object belonging to the first faction may rescue the trapped virtual object.

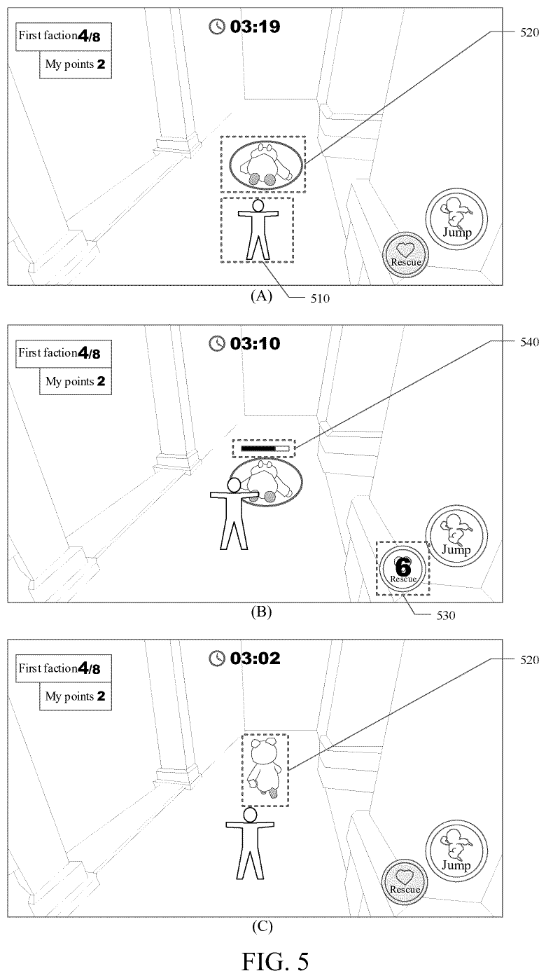

For example, for ease of understanding, FIG. 5 is a schematic diagram of a first virtual object rescuing a second virtual object according to an aspect of this disclosure. As shown in (A) in FIG. 5, 510 indicates the first virtual object, and 520 indicates the second virtual object. In this case, the second virtual object is trapped in a trap and is in an immobilized state.

As shown in (B) in FIG. 5, when the first virtual object approaches the second virtual object trapped in the trap, a rescue control indicated by 530 is displayed. When a player clicks/taps or presses and holds the rescue control indicated by 530, the first virtual object is triggered to initiate a rescue operation on the second virtual object. Therefore, a first progress bar indicated by 540 is displayed. The first progress bar indicates the progress of releasing the immobilized state of the second virtual object. For example, when the player clicks/taps or presses and holds the rescue control indicated by 530, a countdown timer until a successful rescue may further be displayed. For example, the countdown timer shown in the figure is 6 seconds.

When loading of the first progress bar is completed (i.e., loading is finished), an interface shown in (C) in FIG. 5 is displayed. In this case, the response to the target interaction event (i.e., the “rescue event”) is successful. Therefore, the second virtual object indicated by 520 is released from the immobilized state, and regains the ability to freely move in the virtual scene.

In a possible solution design, a virtual object having the target identity information (for example, the “killer” identity) is immune to traps. Based on this, the player may reasonably deduce that a virtual object (for example, the second virtual object 520 in FIG. 5) trapped in the trap belongs to the first faction.

Next, in the aspects of this disclosure, a manner of rescuing another virtual object is provided. In the foregoing manner, virtual objects belonging to the same first faction can further rescue each other. Therefore, on one hand, team collaboration awareness can be enhanced, and cooperative skills between players can be enhanced. On the other hand, social interaction skills may further be enhanced.

In some aspects, based on the foregoing one or more aspects corresponding to FIG. 3, in another aspect provided in the aspects of this disclosure, after the displaying a first progress bar, the method further includes:
resetting a loading progress of the first progress bar if the first virtual object is controlled to end the rescue operation initiated for the second virtual object in a case that the loading of the first progress bar is not completed.

In one or more aspects, a processing manner in a case that a rescue is interrupted is described. It can be known from the foregoing aspect that, in a rescue process, an interruption may occur because a virtual object (for example, the first virtual object) having the first identity information (for example, the “guard” identity) or the second identity information (for example, the “doll” identity) may dodges an attack or for another reason. Based on this, a processing manner in a case that a rescue is interrupted is described below with reference to the drawings.

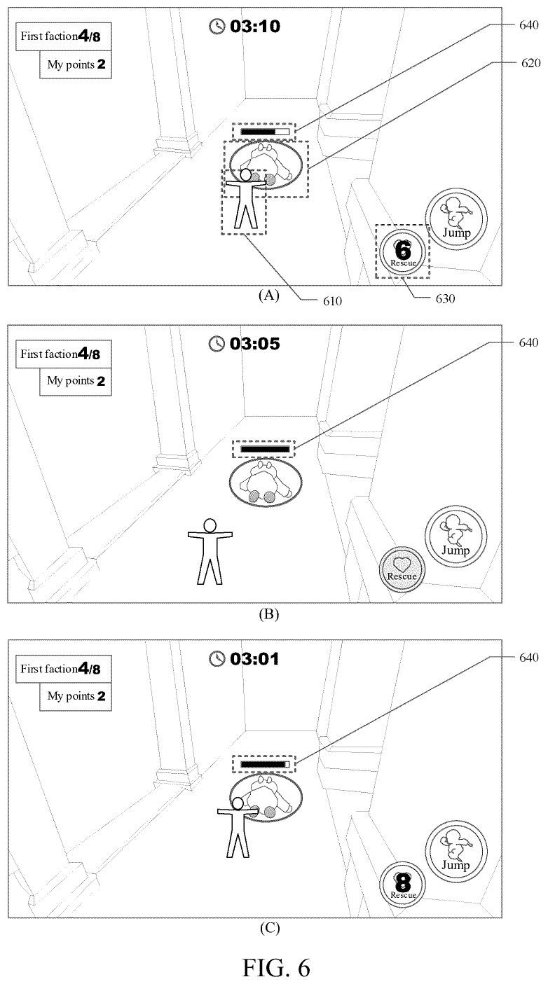

For example, for ease of understanding, FIG. 6 is a schematic diagram of loading a first progress bar according to an aspect of this disclosure. As shown in (A) in FIG. 6, 610 indicates the first virtual object, and 620 indicates the second virtual object. When the first virtual object approaches the second virtual object trapped in the trap, a rescue control indicated by 630 is displayed. When a player clicks/taps or presses and holds the rescue control indicated by 630, the first virtual object is triggered to initiate a rescue operation on the second virtual object. Therefore, a first progress bar indicated by 640 is displayed. The first progress bar indicates the progress of releasing the immobilized state of the second virtual object.

It is assumed that in a process of loading the first progress bar, the player controls the first virtual object to stop rescuing (i.e., end the rescue operation initiated on the second object). Therefore, an interface shown in (B) in FIG. 6 is displayed. In this case, the first progress bar indicated by 640 is reset. As shown in (C) in FIG. 6, when the player controls the first virtual object to initiate a rescue operation on the second virtual object again, the first progress bar indicated by 640 needs to be re-loaded.

Next, in the aspects of this disclosure, a processing manner in a case that a rescue is interrupted is provided. In the foregoing manner, if the rescue process is interrupted, timing needs to be performed again when a rescue is performed again. Therefore, a sense of tension and a sense of excitement in the rescue process are increased.

In some aspects, based on the foregoing one or more aspects corresponding to FIG. 3, in another aspect provided in the aspects of this disclosure, after the displaying a first progress bar, the method further includes:
pausing a loading progress of the first progress bar if the first virtual object is controlled to end the rescue operation initiated for the second virtual object in a case that loading of the first progress bar is not completed; and
controlling the first virtual object to display the first progress bar with progress loading continuing for a rescue operation initiated for the second virtual object again.

In one or more aspects, another processing manner in a case that a rescue is interrupted is described. It can be known from the foregoing aspect that, in a rescue process, an interruption may occur because a virtual object (for example, the first virtual object) having the first identity information (for example, the “guard” identity) or the second identity information (for example, the “doll” identity) may dodges an attack or for another reason. Based on this, a processing manner in a case that a rescue is interrupted is described below with reference to the drawings.

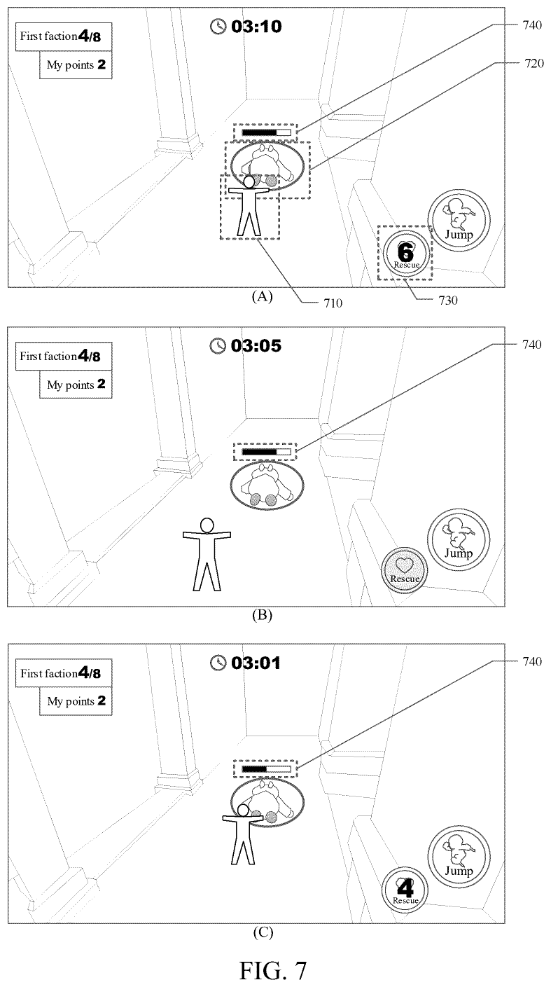

For example, for ease of understanding, FIG. 7 is another schematic diagram of loading a first progress bar according to an aspect of this disclosure. As shown in (A) in FIG. 7, 710 indicates the first virtual object, and 720 indicates the second virtual object. When the first virtual object approaches the second virtual object trapped in the trap, a rescue control indicated by 730 is displayed. When a player clicks/taps or presses and holds the rescue control indicated by 730, the first virtual object is triggered to initiate a rescue operation on the second virtual object. Therefore, a first progress bar indicated by 740 is displayed. The first progress bar indicates the progress of releasing the immobilized state of the second virtual object.

It is assumed that in a process of loading the first progress bar, the player controls the first virtual object to stop rescuing (i.e., end the rescue operation initiated on the second object). Therefore, an interface shown in (B) in FIG. 7 is displayed. In this case, the first progress bar indicated by 740 stops at a position. As shown in (C) in FIG. 7, when the player controls the first virtual object to initiate a rescue operation on the second virtual object again, the first progress bar indicated by 740 continues to be loaded from the position at which the progress stops.

Further, in the aspects of this disclosure, a processing manner in a case that a rescue operation is interrupted is provided. In the foregoing manner, if the rescue process is interrupted, when the rescue is performed again, the rescue may be continued from the position at which the progress is interrupted last time. Therefore, the pace of the game can be increased.

In some aspects, based on the foregoing one or more aspects corresponding to FIG. 3, in another aspect provided in the aspects of this disclosure, the identity information of the first virtual object is the first identity information or the second identity information; and
the method may further include:
displaying a second progress bar when the first virtual object is in an immobilized state, where the second progress bar indicates the progress of releasing the immobilized state of the first virtual object; and
displaying the first virtual object with the immobilized state released in a case that loading of the second progress bar is completed.

In one or more aspects, a manner of automatically releasing a trapped state of a virtual object is described. It can be known from the foregoing aspect that a virtual object (for example, the first virtual object) having the first identity information (for example, the “guard” identity) or the second identity information (for example, the “doll” identity) may be trapped in a trap and therefore is in an immobilized state. If no rescue is attempted within a period of time, the virtual object automatically breaks free from the trap.

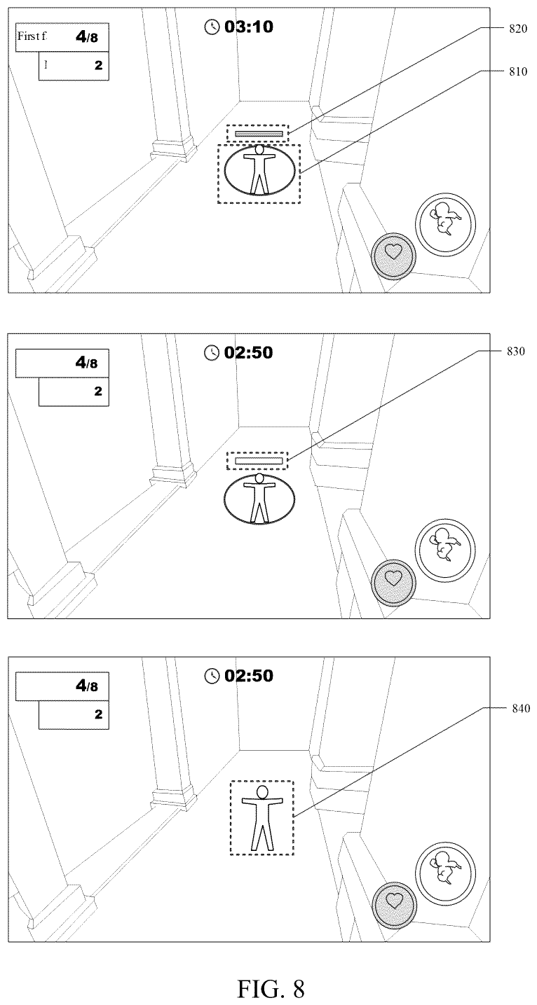

For example, for ease of understanding, FIG. 8 is a schematic diagram of automatically releasing a trapped state of a first virtual object according to an aspect of this disclosure. As shown in (A) in FIG. 8, 810 indicates the first virtual object. In this case, the first virtual object is trapped in a trap and is in an immobilized state. When the first virtual object is trapped in the trap, a second progress bar indicated by 820 is displayed. The second progress bar indicates the progress of releasing the immobilized state of the second virtual object.

It is assumed that in a process of loading the second progress bar, no other virtual object rescues the first virtual object. Based on this, as shown in (B) in FIG. 8, when the loading of the second progress bar is completed (i.e., the loading is finished), the trap automatically disappears, and therefore the trapped state of the first virtual object is automatically released. Based on this, as shown in (C) in FIG. 8, a second virtual object indicated by 840 is released from the immobilized state, and regains the ability to freely move in the virtual scene.

Next, in the aspects of this disclosure, a manner of automatically releasing a trapped state of a virtual object is provided. In the foregoing manner, if being trapped in the trap without any rescue for a period of time, the virtual object is automatically released from the trap. Therefore, a case in which a player cannot continue with the subsequent game without any rescue for a long time can be avoided. In this way, the reasonableness and feasibility of the gameplay are improved.

In some aspects, based on the foregoing one or more aspects corresponding to FIG. 3, in another aspect provided in the aspects of this disclosure, the identity information of the second virtual object is the first identity information or the second identity information; and
after the displaying a second progress bar, the method may further include:
displaying a third progress bar in response to a rescue operation initiated by the second virtual object with the first virtual object, where the third progress bar indicates the progress of releasing the immobilized state of the first virtual object, and duration required for loading of the third progress bar to be completed is less than duration required for the loading of the second progress bar to be completed.

In one or more aspects, a manner of a virtual object being rescued by another virtual object from the same faction is described. It can be known from the foregoing aspect that a virtual object (for example, the first virtual object) having the first identity information (for example, the “guard” identity) or the second identity information (for example, the “doll” identity) may be trapped in a trap and therefore is in an immobilized state. Therefore, another virtual object belonging to the first faction may rescue the trapped virtual object.

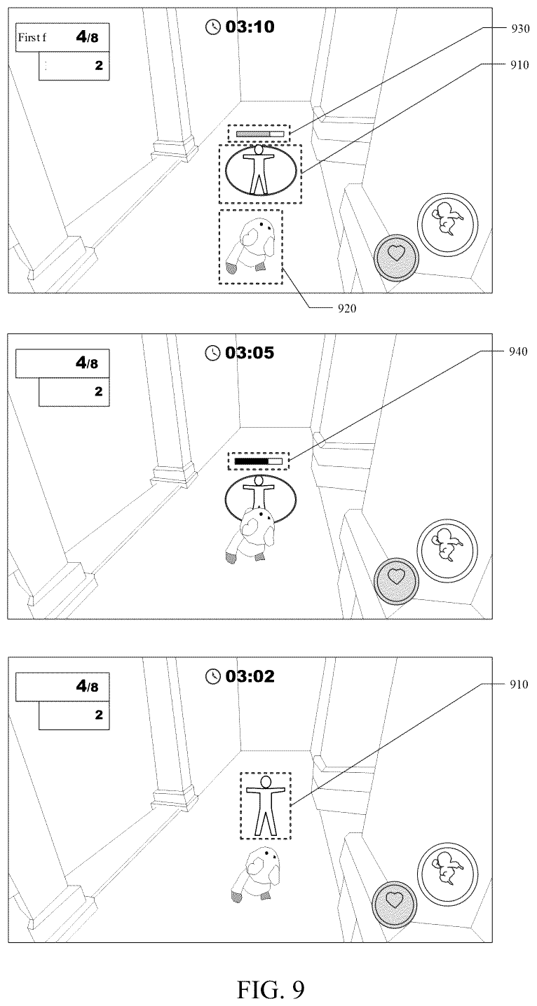

For example, for ease of understanding, FIG. 9 is a schematic diagram of a second virtual object rescuing a first virtual object according to an aspect of this disclosure. As shown in (A) in FIG. 9, 910 indicates the first virtual object, and 920 indicates the second virtual object. In this case, the first virtual object is trapped in a trap and is in an immobilized state. When the first virtual object is trapped in the trap, a second progress bar indicated by 930 is displayed. The second progress bar indicates the progress of releasing the immobilized state of the second virtual object.

As shown in (B) in FIG. 9, when the second virtual object approaches the first virtual object trapped in the trap, the second virtual object may initiate the rescue operation on the first virtual object. Therefore, a third progress bar indicated by 940 is displayed. The third progress bar indicates the progress of releasing the immobilized state of the first virtual object. The duration required for the loading of the third progress bar to be completed is less than the duration required for the loading of the second progress bar to be completed. For example, the duration required for the loading of the second progress bar to be completed is 20 seconds, and the duration required for completing loading of the third progress bar is 10 seconds. It can be learned that the virtual object needs to wait for a longer period of time to be automatically released from the trapped state. Therefore, the significance of being rescued by a player from the same faction is clearer.

When the loading of the third progress bar is completed (i.e., the loading is finished), an interface shown in (C) in FIG. 9 is displayed. In this case, the first virtual object indicated by 910 is released from the immobilized state, and regains the ability to freely move in the virtual scene.

Further, in the aspects of this disclosure, a manner of a virtual object being rescued by another virtual object from the same faction is provided. In the foregoing manner, in a case that a virtual object is trapped, the rescuing of the virtual object by another virtual object from the same faction is supported. Therefore, team collaboration awareness can be enhanced, and cooperative skills between players can be enhanced.

In some aspects, based on the foregoing one or more aspects corresponding to FIG. 3, in another aspect provided in the aspects of this disclosure, the identity information of the first virtual object is the first identity information, and the identity information of the second virtual object is the first identity information, the second identity information, or the target identity information.

The controlling the first virtual object to initiate a target interaction event with a second virtual object may include:
controlling the first virtual object to initiate an attack operation on the second virtual object;
the displaying an interaction event result corresponding to the target interaction event in a case that response to the target interaction event is successful may include:
determining that the response to the target interaction event is successful in a case that the second virtual object is hit by the first virtual object, and eliminating the second virtual object from the target game match.

In one or more aspects, a manner of triggering an attack by a first virtual object having the first identity information is described. It can be known from the foregoing aspect that a virtual object (for example, the first virtual object) having the first identity information (for example, the “guard” identity) further has an attack capability. Therefore, the virtual object may initiate an attack operation on a virtual object having any identity information.

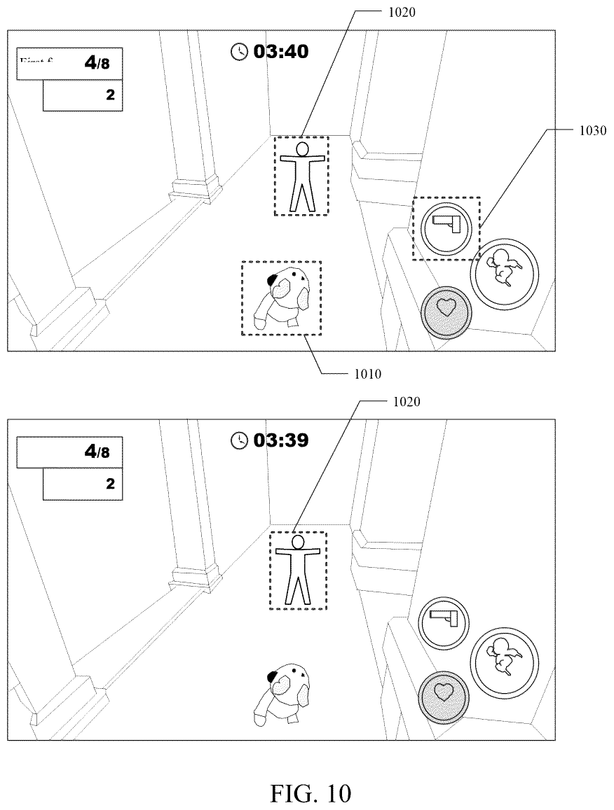

For example, for ease of understanding, FIG. 10 is a schematic diagram of a first virtual object initiating an attacking operation on a second virtual object according to an aspect of this disclosure. As shown in (A) in FIG. 10, 1010 indicates the first virtual object, 1020 indicates the second virtual object, and 1030 indicates a shoot control. When a player clicks/taps the shoot control indicated by 1030, the first virtual object is triggered to initiate an attack operation on the second virtual object. When the second virtual object is hit by the first virtual object, an interface shown in (B) in FIG. 10 is displayed. In this case, the response to the target interaction event (i.e., a “ranged attack event”) is successful. Therefore, the second virtual object indicated by 1020 is eliminated from the target game match.

The virtual object having the first identity information shoots at a target, a hit virtual object is eliminated. A shooting interval time of the virtual object may be set to one second, or another value. This is not limited herein.

Next, in the aspects of this disclosure, a manner of triggering an attack by a first virtual object having the first identity information is provided. In the foregoing manner, a virtual object may further trigger an attack on another virtual object, and a hit virtual object is eliminated. It can be learned that players are mainly engaged in competitive forms such as intense and fierce real-time combat and pursuit and escape, thereby lowering the entry barrier to the game and increasing the pace of the game.

In some aspects, based on the foregoing one or more aspects corresponding to FIG. 3, in another aspect provided in the aspects of this disclosure, after the controlling the first virtual object to initiate an attack operation on the second virtual object, the method may include:
controlling, in response to a touch operation on a shoot control, the first virtual object to enter a shooting preparation state, and displaying an aiming line trajectory, where the aiming line trajectory is a trajectory that extends from a trajectory start point position of a shooting prop to a trajectory end point position and is configured for previewing a shooting path; and
determining that the second virtual object is hit by the first virtual object if the aiming line trajectory collides with a collision box of the second virtual object in response to a release operation on the shoot control.

In one or more aspects, a manner of performing a ranged attack by a first virtual object having the first identity information is described. It can be known from the foregoing aspect that a virtual object (for example, the first virtual object) having the first identity information (for example, the “guard” identity) may initiate a ranged attack on a virtual object having any identity information.

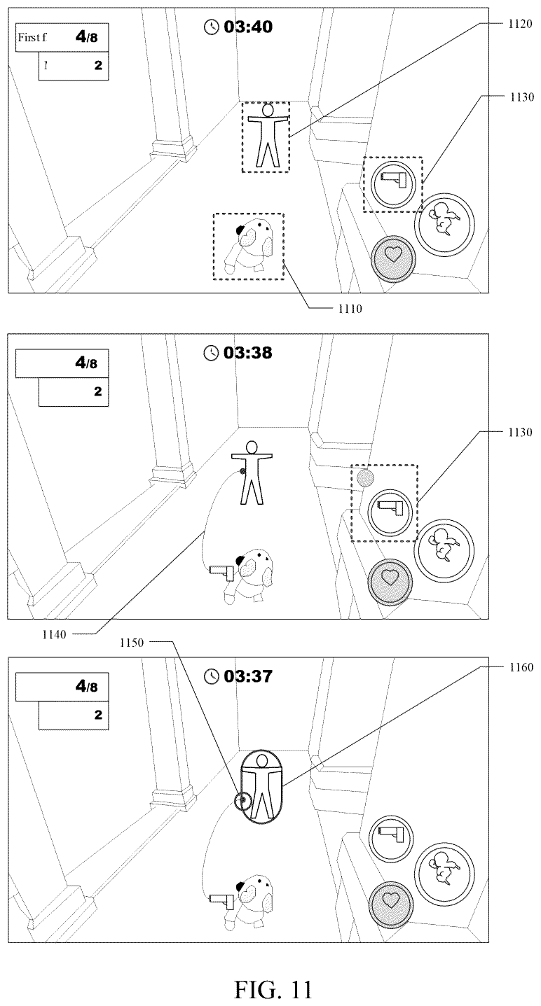

For example, for ease of understanding, FIG. 11 is a schematic diagram of a first virtual object initiating a ranged attack according to an aspect of this disclosure. As shown in (A) in FIG. 11, 1110 indicates the first virtual object, 1120 indicates the second virtual object, and 1130 indicates a shoot control. As shown in (B) in FIG. 11, when a player clicks/taps a shoot control indicated by 1130, the first virtual object enters a shooting preparation state. In this case, an aiming action is played through animation blending. A pre-designated shooting prop model is loaded to the hand bone of the first virtual object, and an aiming line trajectory indicated by 1140 is displayed. The aiming line trajectory is dynamically generated by a program based on art-provided base models and according to parabolic parameters. A corresponding direction change is performed based on a drag trajectory of the player on a shooting button to implement a function that the first virtual object aims around.

When the first virtual object is in the shooting preparation state, if the player releases the shoot control, a release operation on the shoot control is triggered. In this case, the first virtual object is controlled to initiate an attack operation on the second virtual object. Therefore, the first virtual object immediately fires one shot, and a virtual bullet is launched along the aiming line trajectory indicated by 1140.

As shown in (C) in FIG. 11, an end point of the aiming line trajectory is an end point position of the virtual bullet. 1150 indicates a collision box (i.e., a mesh approximately similar to the virtual bullet) that is attached to the virtual bullet and is configured for collision detection. In addition, 1160 indicates a collision box (i.e., a capsule-shaped mesh located at the center of the second virtual object) that is attached to the second virtual object and is configured for collision detection. If the collision box of the virtual bullet hits the collision box of the second virtual object, indicating that the aiming line trajectory collides with the collision box of the second virtual object, the first virtual object hits the second virtual object in the attack.

The foregoing interface may further include a shooting prop, for example, a virtual gun, a virtual dart, or a virtual explosive. The shooting prop may be a prop held by a virtual object, or may be a prop placed in a virtual scene when a game starts. This is not limited herein.

In a possible solution design, a virtual object having the first identity information (for example, the “guard” identity) holds a specific shooting prop. Based on this, if a player assigned the first identity information believes that an opposing player belongs to the same faction, the player may further perform an aiming action to show the identity of the player through the shooting prop during aiming, thereby establishing the mutual trust.

Further, in the aspects of this disclosure, a manner of performing a ranged attack by a first virtual object having the first identity information is provided. In the foregoing manner, the virtual object having the first identity information may perform a ranged attack on another virtual object, and in an attack process, a corresponding aiming line trajectory is displayed. Therefore, the aiming difficulty is reduced, which is beneficial to increasing the pace of the game, thereby better suiting the fragmented play sessions on mobile terminals.

In some aspects, based on the foregoing one or more aspects corresponding to FIG. 3, in another aspect provided in the aspects of this disclosure, after the eliminating the second virtual object from the target game match, the method further includes:
displaying a first match settlement result of the target game match if the identity information of the second virtual object is the target identity information and the second virtual object is the last surviving virtual object from the second faction, where the first match settlement result indicates that the first faction has defeated the second faction.

In one or more aspects, a processing case of a first virtual object making an attack correctly is described. It can be known from the foregoing aspect that after being hit in the attack, the second virtual object is eliminated from the target game match. Based on this, if the identity information of the second virtual object is the target identity information (for example, the “killer” identity), whether a surviving virtual object still exists in the second faction further needs to be determined. If a surviving virtual object still exists in the second faction, the target game match continues. In contrast, if no surviving virtual object exists in the second faction, the target game match ends, and the settlement stage is entered. In this case, the first faction has defeated the second faction.

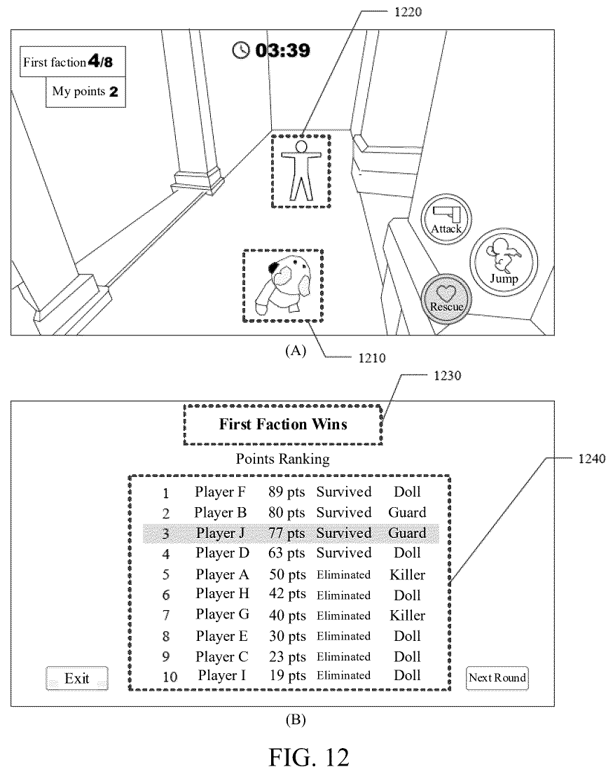

For example, for ease of understanding, FIG. 12 is a schematic diagram of displaying a first match settlement result according to an aspect of this disclosure. As shown in (A) in FIG. 12, 1210 indicates the first virtual object, and 1220 indicates the second virtual object. If the identity information of the second virtual object is the target identity information and the second virtual object is the last surviving virtual object from the second faction, after being hit and eliminated by the first virtual object, the current target game match is ended. Therefore, an interface shown in (B) in FIG. 12 is displayed. The figure shows a first match settlement result indicated by 1230. The first match settlement result indicates that the first faction has defeated the second faction. In addition, settlement results such as point awards indicated by 1240 may be further displayed. Assuming that the player controlling a first virtual role is “Player J”, a point award and other related information of the player are further highlighted in the settlement results such as the point awards.

Further, in the aspects of this disclosure, a processing manner of a first virtual object making an attack correctly is provided. In the foregoing manner, if a virtual object belonging to the first faction hits a virtual object belonging to the second faction, the virtual object from the second faction may be directly eliminated, thereby protecting other players from the first faction. Meanwhile, when all virtual objects from the second faction are eliminated, it indicates that the first faction has defeated the second faction. Therefore, the immersion and intuitiveness of the gameplay are improved.

In some aspects, based on the foregoing one or more aspects corresponding to FIG. 3, in another aspect provided in the aspects of this disclosure, after the eliminating the second virtual object from the target game match, the method further includes:
reducing a current quantity of surviving objects of the first faction if the identity information of the second virtual object is the first identity information or the second identity information.

In one or more aspects, a processing manner of a virtual object making an attack incorrectly is described. It can be known from the foregoing aspect that after being hit in the attack, the second virtual object is eliminated from the target game match. Based on this, if the identity information of the second virtual object is the first identity information (for example, the “guard” identity) or the second identity information (for example, the “doll” identity), the current quantity of surviving objects of the first faction is reduced.

In a possible solution design, if the first virtual object hits another virtual object from the same faction, the first virtual object is also eliminated. Based on this, whether a surviving virtual object still exists in the first faction further needs to be determined. If a surviving virtual object still exists in the first faction, the target game match continues. In contrast, if no surviving virtual object exists in the first faction, the target game match ends, and the settlement stage is entered. In this case, the second faction has defeated the first faction.

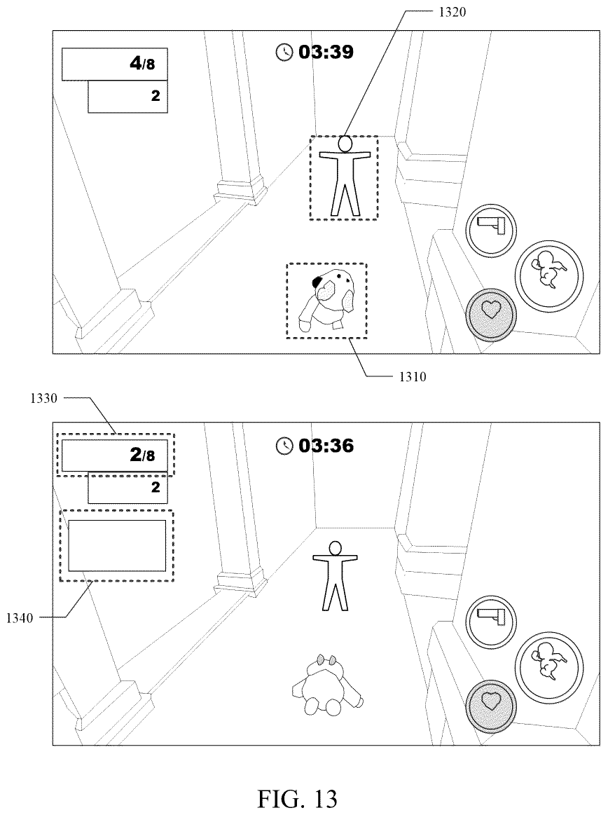

For example, for ease of understanding, FIG. 13 is a schematic diagram of updating current quantity of surviving objects according to an aspect of this disclosure. As shown in (A) in FIG. 13, 1310 indicates the first virtual object, and 1320 indicates the second virtual object. It is assumed that the identity information of the second virtual object is the first identity information or the second identity information, and in this case, four surviving virtual objects exist in the first faction. Assuming that the first virtual object hits the second virtual object, both the first virtual object and the second virtual object are eliminated.

Therefore, an interface shown in (B) in FIG. 13 is displayed. 1330 indicates the current quantity of surviving objects of the first faction, “2/8” represents that the first faction includes a total of eight virtual objects, and the current quantity of surviving objects is 2. 1340 indicates an elimination prompt, i.e., displays the nicknames of eliminated players. For example, “Player J” controls the first virtual object, and “Player E” controls the second virtual object. For example, the elimination prompt displays “Player J is eliminated, and Player E is eliminated”.

Further, in the aspects of this disclosure, a processing manner of a virtual object making an attack incorrectly is provided. In the foregoing manner, if a virtual object belonging to the first faction incorrectly attacks a virtual object controlled by another player from the same faction, the hit virtual object is directly eliminated, resulting in a reduction in the quantity of surviving objects of the same faction. Therefore, a player needs to properly recognize the identity of an opposing player, thereby increasing the tension of the game and adding a strategic element.

In some aspects, based on the foregoing one or more aspects corresponding to FIG. 3, in another aspect provided in the aspects of this disclosure, the identity information of the first virtual object is the target identity information, and the identity information of the second virtual object is the first identity information or the second identity information.

The controlling the first virtual object to initiate a target interaction event with a second virtual object may include:
controlling the first virtual object to initiate an attack operation on the second virtual object;
the displaying an interaction event result corresponding to the target interaction event in a case that response to the target interaction event is successful may include:
determining that the response to the target interaction event is successful in a case that the second virtual object is hit by the first virtual object, and eliminating the second virtual object from the target game match.

In one or more aspects, a manner of triggering an attack by a first virtual object having the target identity information is described. It can be known from the foregoing aspect that a virtual object (for example, the first virtual object) having the target identity information (for example, the “killer” identity) has an attack capability. Therefore, the virtual object may initiate an attack operation on a virtual object from the first faction.

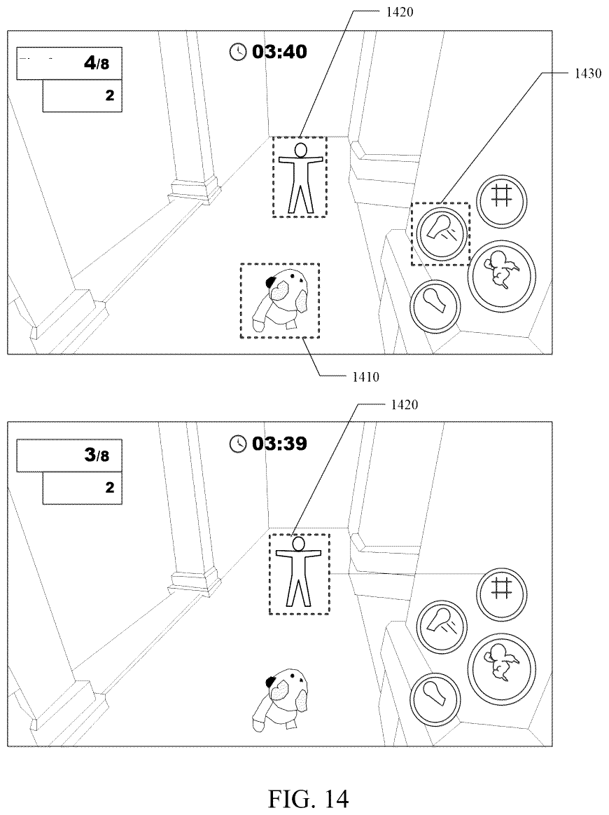

For example, for ease of understanding, FIG. 14 is another schematic diagram of a first virtual object initiating an attacking operation on a second virtual object according to an aspect of this disclosure. As shown in (A) in FIG. 14, 1410 indicates the first virtual object, 1420 indicates the second virtual object, and 1430 indicates a throw control. When a player clicks/taps the throw control indicated by 1430, the first virtual object is triggered to initiate an attack operation on the second virtual object. When the second virtual object is hit by the first virtual object, an interface shown in (B) in FIG. 14 is displayed. In this case, the response to the target interaction event (i.e., a “ranged attack event”) is successful. Therefore, the second virtual object indicated by 1420 is eliminated from the target game match.

The virtual object having the target identity information throws a throwing prop at a target, a hit virtual object is eliminated. A throwing interval time of the throwing prop may be set to six seconds, or another value. This is not limited herein. In a possible solution design, both a virtual object having the first identity information (for example, the “guard” identity) and a virtual object having the target identity information (for example, the “killer” identity) are displayed as normal roles in a non-combat state. Therefore, the identities of each other cannot be identified through appearances. However, in a combat state, a virtual object having the target identity information (for example, the “killer” identity) holds a specific throwing prop. Based on this, a player may reasonably deduce that a virtual object holding the throwing prop is a “killer” belonging to the second faction.

Next, in the aspects of this disclosure, a manner of triggering an attack by a first virtual object having the target identity information is provided. In the foregoing manner, a virtual object may further trigger an attack on another virtual object, and a hit virtual object is eliminated. It can be learned that players are mainly engaged in competitive forms such as intense and fierce real-time combat and pursuit and escape, thereby lowering the entry barrier to the game and increasing the pace of the game.

In some aspects, based on the foregoing one or more aspects corresponding to FIG. 3, in another aspect provided in the aspects of this disclosure, after the controlling the first virtual object to initiate an attack operation on the second virtual object, the method may include:
controlling, in response to a touch operation on a throw control, the first virtual object to enter a throwing preparation state, and displaying an aiming line trajectory, where the aiming line trajectory is a trajectory that extends from a trajectory start point position of a throwing prop to a trajectory end point position and is configured for previewing a throwing path; and
determining that the second virtual object is hit by the first virtual object if the aiming line trajectory collides with a collision box of the second virtual object in response to a release operation on the throw control.

In one or more aspects, a manner of performing a ranged attack by a first virtual object having the target identity information is described. It can be known from the foregoing aspect that, a virtual object (for example, the first virtual object) having the target identity information (for example, the “killer” identity) may perform a ranged attack on a virtual object having the first identity information or the second identity information.

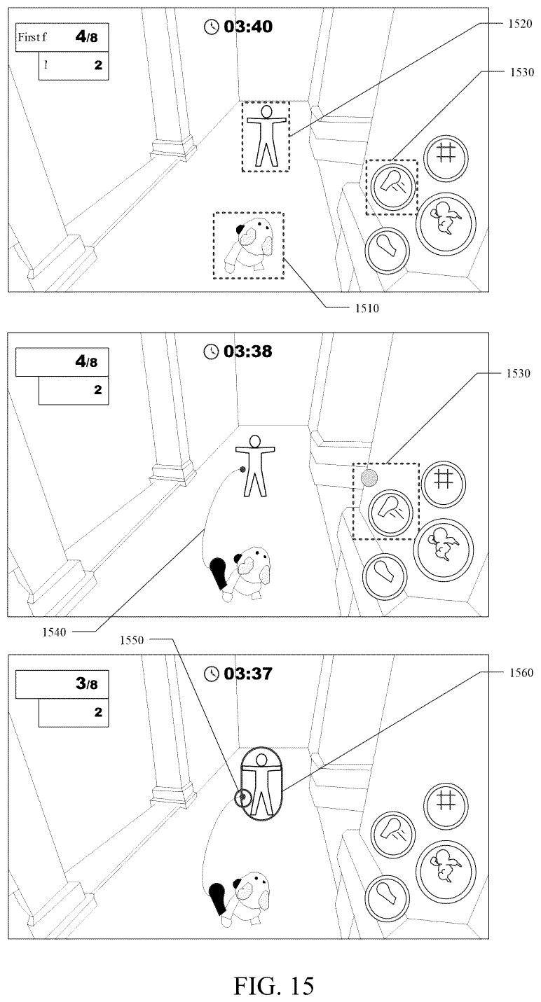

For example, for ease of understanding, FIG. 15 is another schematic diagram of a first virtual object initiating a ranged attack according to an aspect of this disclosure. As shown in (A) in FIG. 15, 1510 indicates the first virtual object, 1520 indicates the second virtual object, and 1530 indicates a throw control. As shown in (B) in FIG. 15, when a player clicks/taps a throw control indicated by 1530, the first virtual object enters a throwing preparation state. In this case, an aiming action is played through animation blending. A pre-designated throwing prop model is loaded to the hand bone of the first virtual object, and an aiming line trajectory indicated by 1540 is displayed. The aiming line trajectory is dynamically generated by a program based on art-provided base models and according to parabolic parameters. A corresponding direction change is performed based on a drag trajectory of the player on a throw control to implement a function that the first virtual object aims around.

When the first virtual object is in the throwing preparation state, if the player releases the throw control, a release operation on the throw control is triggered. In this case, the first virtual object is controlled to initiate an attack operation on the second virtual object. Therefore, the first virtual object immediately performs one throw, and a throwing prop is launched along the aiming line trajectory indicated by 1540.

As shown in (C) in FIG. 15, an end point of the aiming line trajectory is an end point position of the throwing prop. 1550 indicates a collision box (i.e., a mesh approximately similar to the throwing prop) that is attached to the throwing prop and is configured for collision detection. In addition, 1560 indicates a collision box (i.e., a capsule-shaped mesh located at the center of the second virtual object) that is attached to the second virtual object and is configured for collision detection. If the collision box of the throwing prop hits the collision box of the second virtual object, indicating that the aiming line trajectory collides with the collision box of the second virtual object, the first virtual object hits the second virtual object in the attack.

The foregoing interface may further include a throwing prop, for example, a virtual club, a virtual baseball, or a virtual stone. The throwing prop may be a prop held by a virtual object, or may be a prop placed in a virtual scene when a game starts. This is not limited herein. In addition, a type of the throwing prop is different from that of the shooting prop.

Further, in the aspects of this disclosure, a manner of performing a ranged attack by a first virtual object having the target identity information is provided. In the foregoing manner, the virtual object having the target identity information may perform a ranged attack on another virtual object, and in an attack process, a corresponding aiming line trajectory is displayed. Therefore, the aiming difficulty is reduced, which is beneficial to increasing the pace of the game, thereby better suiting the fragmented play sessions on mobile terminals.

In some aspects, based on the foregoing one or more aspects corresponding to FIG. 3, in another aspect provided in the aspects of this disclosure, after the controlling the first virtual object to initiate an attack operation on the second virtual object, the method may include:
controlling the first virtual object to swing an attacking prop in response to a selection operation on an attack control; and
determining that the second virtual object is hit by the first virtual object if the attacking prop collides with a collision box of the second virtual object.

In one or more aspects, a manner of performing a melee attack by a first virtual object having the target identity information is described. It can be known from the foregoing aspect that a virtual object (for example, the first virtual object) having the target identity information (for example, the “killer” identity) has an attack capability. Therefore, the virtual object may initiate an attack operation on a virtual object from the first faction.

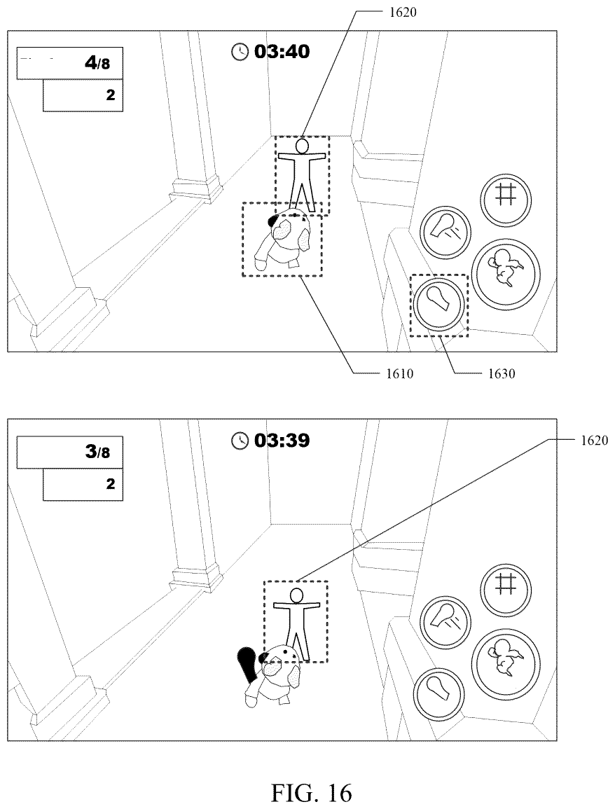

For example, for ease of understanding, FIG. 16 is a schematic diagram of a first virtual object initiating a melee attack according to an aspect of this disclosure. As shown in (A) in FIG. 16, 1610 indicates the first virtual object, 1620 indicates the second virtual object, and 1630 indicates an attack control. When a player clicks/taps the attack control indicated by 1630, i.e., a selection operation on the attack control is triggered. Therefore, the first virtual object swings the attacking prop toward the second virtual object and initiates an attack operation. When the second virtual object is hit by the first virtual object, an interface shown in (B) in FIG. 16 is displayed. In this case, the response to the target interaction event (i.e., a “melee attack event”) is successful. Therefore, the second virtual object indicated by 1620 is eliminated from the target game match.

A collision box (i.e., a mesh approximately similar to the attacking prop) for collision detection is attached to the attacking prop. In addition, a collision box (i.e., a capsule-shaped mesh located at the center of the second virtual object) for collision detection is also attached to the second virtual object. If the collision box of the attacking prop hits the collision box of the second virtual object, the first virtual object hits the second virtual object in the attack.

The virtual object having the target identity information swings the attacking prop once toward a target, a hit virtual object is eliminated. A swinging interval time of the attacking prop may be set to three seconds, or another value. This is not limited herein. In a possible solution design, both a virtual object having the first identity information (for example, the “guard” identity) and a virtual object having the target identity information (for example, the “killer” identity) are displayed as normal roles in a non-combat state. Therefore, the identities of each other cannot be identified through appearances. However, in a combat state, a virtual object having the target identity information (for example, the “killer” identity) holds a specific attacking prop. Based on this, a player may reasonably deduce that a virtual object holding the attacking prop is a “killer” belonging to the second faction.

Assuming that a virtual object having the first identity information (for example, the “guard” identity) may also launch a melee attack, an attacking prop used by the virtual object having the first identity information is inconsistent with an attacking prop used by the virtual object having the target identity information. For example, the attacking prop used by the virtual object having the first identity information may be a virtual baton, a virtual stun baton, or the like, and the attacking prop used by the virtual object having the target identity information may be a virtual club, a virtual pan, or the like.

Further, in the aspects of this disclosure, a manner of performing a melee attack by a first virtual object having the target identity information is provided. In the foregoing manner, the virtual object having the target identity information may perform a melee attack on another virtual object without aiming, thereby achieving a rapid attack.

In some aspects, based on the foregoing one or more aspects corresponding to FIG. 3, in another aspect provided in the aspects of this disclosure, after the eliminating the second virtual object from the target game match, the method further includes:
displaying a second match settlement result if the identity information of the second virtual object is the first identity information or the second identity information and the second virtual object is the last surviving virtual object from the first faction, where the second match settlement result indicates that the second faction has defeated the first faction;
reducing a current quantity of surviving objects of the first faction if the identity information of the second virtual object is the first identity information and the first faction still includes at least one surviving virtual object, and displaying that a shooting prop currently used by the second virtual object drops; and
reducing the current quantity of surviving objects of the first faction if the identity information of the second virtual object is the second identity information and the first faction still includes at least one surviving virtual object.

In one or more aspects, a processing manner of a first virtual object making an attack correctly is described. It can be known from the foregoing aspect that after being attacked, the second virtual object is eliminated from the target game match. Based on this, if the identity information of the second virtual object is the first identity information (for example, the “guard” identity) or the second identity information (for example, the “doll” identity), whether a surviving virtual object still exists in the first faction further needs to be determined. If a surviving virtual object still exists in the first faction, the target game match continues. In contrast, if no surviving virtual object exists in the first faction, the target game match ends, and the settlement stage is entered. In this case, the second faction has defeated the first faction.

For example, if the identity information of the second virtual object is the first identity information (for example, the “guard” identity) and a surviving virtual object exists in the first faction, after the first virtual object hits the second virtual object, the second virtual object is eliminated, and an updated current quantity of surviving objects of the first faction is displayed (i.e., the current quantity of surviving objects is reduced by 1). Meanwhile, the shooting prop held by the second virtual object may drop in the virtual scene.

For example, if the identity information of the second virtual object is the second identity information (for example, the “doll” identity) and a surviving virtual object exists in the first faction, after the first virtual object hits the second virtual object, the second virtual object is eliminated, and an updated current quantity of surviving objects of the first faction is displayed (i.e., the current quantity of surviving objects is reduced by 1).

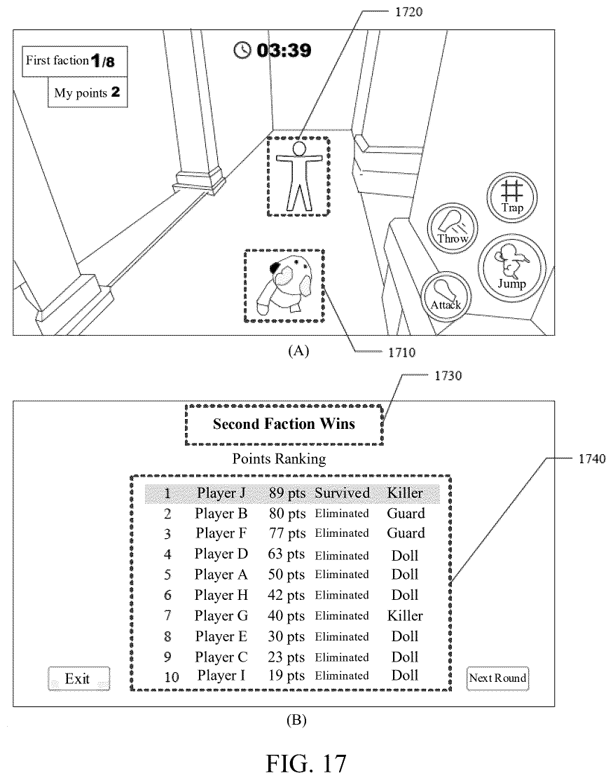

For example, for ease of understanding, FIG. 17 is a schematic diagram of displaying a second match settlement result according to an aspect of this disclosure. As shown in (A) in FIG. 17, 1710 indicates the first virtual object, and 1720 indicates the second virtual object. If the identity information of the second virtual object is the first identity information or the second identity information and the second virtual object is the last surviving virtual object from the first faction, after being hit and eliminated by the first virtual object, the current target game match is ended. Therefore, an interface shown in (B) in FIG. 17 is displayed. The figure shows a second match settlement result indicated by 1730. The second match settlement result indicates that the second faction has defeated the first faction. In addition, settlement results such as point awards indicated by 1740 may be further displayed. Assuming that the player controlling a first virtual role is “Player J”, a point award and other related information of the player are further highlighted in the settlement results such as the point awards.

Further, in the aspects of this disclosure, a processing manner of a first virtual object making an attack correctly is provided. In the foregoing manner, after a game starts, virtual objects having the target identity information may search a virtual scene for virtual objects from the first faction, and win the game by attacking the virtual objects from the first faction. A player from the first faction does not know which virtual objects have the target identity information. Therefore, a player obtaining the target identity information may attack virtual objects from the first faction by using this asymmetry in information, and needs to stay vigilant against attacks from the virtual objects having the first identity information. Therefore, the fun of the gameplay is increased, and richer strategic elements are added to the game.

In some aspects, based on the foregoing one or more aspects corresponding to FIG. 3, in another aspect provided in the aspects of this disclosure, the identity information of the first virtual object is the second identity information; and
the method may further include:
displaying a shooting prop in a virtual scene of the target game application, where the shooting prop drops from a virtual object having the first identity information; and
controlling, in response to a picking operation on the shooting prop, the first virtual object to pick up the shooting prop, and switching the identity information of the first virtual object to the first identity information, where a picking manner of the shooting prop includes picking and using or picking and carrying.

In one or more aspects, a manner of a virtual object changing identity information is described. It can be known from the foregoing aspect that when a virtual object having the first identity information (for example, the “guard” identity) is eliminated, a shooting prop held by the virtual object may drop in the virtual scene. If a virtual object (for example, the first virtual object) having the second identity information (for example, the “doll” identity) picks up the shooting prop, the identity information of the virtual object is changed to the first identity information.

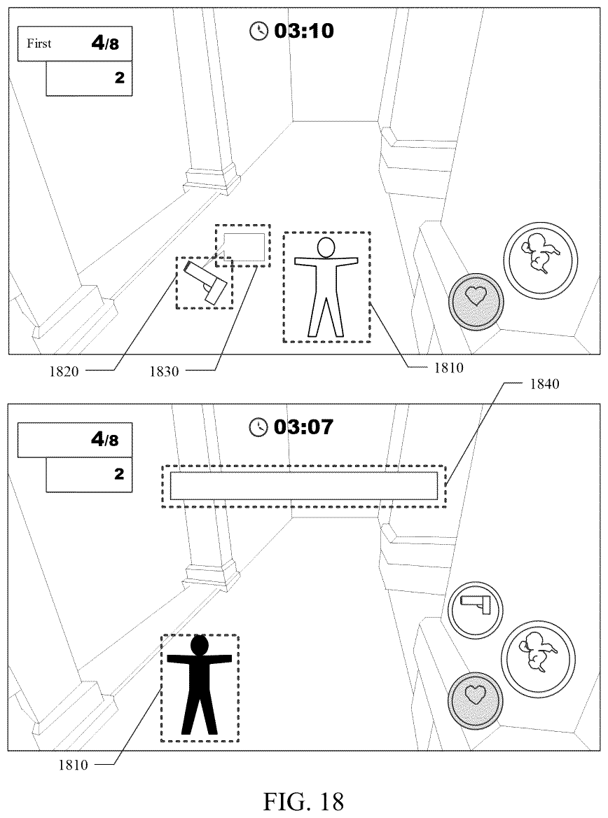

For example, for ease of understanding, FIG. 18 is a schematic diagram of a first virtual object switching identity information according to an aspect of this disclosure. As shown in (A) in FIG. 18, 1810 indicates the first virtual object, 1820 indicates a shooting prop that drops in the virtual scene, and 1830 indicates a prop prompt icon. For example, a shooting prop that drops in the virtual scene is prompted. The collision box of the first virtual object collides with the collision box of the shooting prop, indicating a picking operation performed by the first virtual object on the shooting prop. Therefore, the first virtual object is triggered to pick up the shooting prop.

Based on this, as shown in (B) in FIG. 18, after the first virtual object picks up the shooting prop indicated by 1810, the identity information corresponding to the first virtual object is switched from the second identity information to the first identity information. 1840 indicates a general prompt. In this case, the first virtual object controlled by the player is prompted that the identity information has been switched. After picking up the virtual prop, the first virtual object may use the virtual prop directly or carry the virtual prop. This is not limited herein.

Next, in the aspects of this disclosure, a manner of a virtual object changing identity information is provided. In the foregoing manner, if a virtual object holding a shooting prop is eliminated, the shooting prop that drops from the virtual object may alternatively be picked up by another virtual object from the same faction. Based on this, the virtual object picking up the shooting prop is updated from the first identity information to the second identity information. Therefore, not only the balance between factions can be better maintained, but also the diversity and fun of the gameplay are improved.

In some aspects, based on the foregoing one or more aspects corresponding to FIG. 3, in another aspect provided in the aspects of this disclosure, the identity information of the first virtual object is the target identity information, and the identity information of the second virtual object is the target identity information; and
the method may further include:
displaying a target identity list, where the target identity list includes information about T virtual objects, identity information of each of the T virtual objects is the target identity information, and T is an integer greater than 1;
or,
displaying the identity information of the second virtual object in a virtual scene of the target game application;
or,
highlighting, in the target game match in a virtual scene of the target game application, the second virtual object relative to a virtual object whose identity information is not the target identity information.

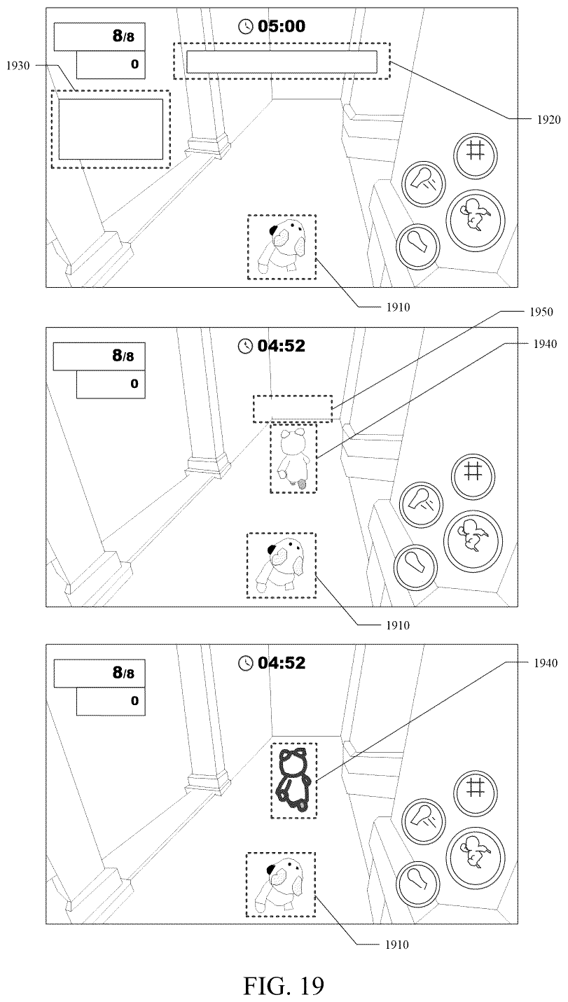

In one or more aspects, a manner of displaying identity information of a virtual object from the second faction is described. It can be known from the foregoing aspect that a virtual object (for example, the first virtual object) having the target identity information (for example, the “killer” identity) may know another virtual object having the target identity information (for example, the “killer” identity). For example, virtual objects from the second faction may know the identity information of each other, and based on this, may further cooperate and communicate with each other in subsequent combats. Three manners of knowing players from the second faction knowing the identity information of each other are described below with reference to FIG. 19. FIG. 19 is a schematic diagram of disclosing identity information to a second faction according to an aspect of this disclosure.

### Manner 1:

As shown in (A) in FIG. 19, 1910 indicates a first virtual object. 1920 indicates a general prompt. In this case, it is prompted that the first virtual object controlled by the player has the target identity information. 1930 indicates a target identity list. Information (for example, nicknames of players or nicknames of virtual objects) about two virtual objects is displayed in the target identity list. In this case, T is equal to 2. Based on this, the player controlling the first virtual object can learn that in the current match, both “Player J” and “Player G” belong to the second faction.

The target identity list is visible to only players from the second faction, and the target identity list is not visible to players from the first faction.

### Manner 2:

As shown in (B) in FIG. 19, 1910 indicates a first virtual object. 1940 indicates a second virtual object. 1950 indicates identity information of the second virtual object. For example, it is displayed that the second virtual object has target identity information. Based on this, the player controlling the first virtual object can learn that in the current match, “Player G” belongs to the second faction.

A prompt related to the identity information is visible to only players from the second faction, and a prompt related to the identity information is not visible to players from the first faction. During actual application, identity information is prompted by using fonts of different colors. For example, “Player G” is displayed in a red font.

### Manner 3:

As shown in (C) in FIG. 19, 1910 indicates a first virtual object. 1940 indicates a second virtual object. The second virtual object indicated by 1940 is in a highlighted state. Based on this, the player controlling the first virtual object can learn that in the current match, the second virtual object belongs to the second faction.

The highlighting of a virtual object is visible to only players from the second faction, and the highlighting of other virtual objects is not visible to players from the first faction.

Next, in the aspects of this disclosure, a manner of displaying identity information of a virtual object from the second faction is displayed. In the foregoing manner, virtual objects belonging to the second faction can know the identity information of each other. Based on this, players belonging to the second faction may further cooperate with each other, thereby improving the strategic depth of the gameplay of the game.

In some aspects, based on the foregoing one or more aspects corresponding to FIG. 3, in another aspect provided in the aspects of this disclosure, the identity information of the first virtual object is the target identity information; and
the method may further include:
playing a trap deployment animation of the first virtual object in response to a trap deployment operation; and
placing a trap prop in a virtual scene of the target game application when the playing of the trap deployment animation is completed, where the trap prop is configured for keeping a virtual object from the first faction at a proximity distance from the trap prop being less than or equal to a proximity distance threshold in an immobilized state.

In one or more aspects, a processing manner of a first virtual object deploys a trap is described. It can be known from the foregoing aspect that, a virtual object (for example, the first virtual object) having the target identity information (for example, the “killer” identity) has a trap deployment capability. A virtual object from the first faction can be trapped in a deployed trap, so that a virtual object having the first identity information (for example, the “guard” identity) or the second identity information (for example, the “doll” identity) is in an immobilized state, and needs to wait for being rescued by another player from the same faction or wait for the trap to be automatically released.

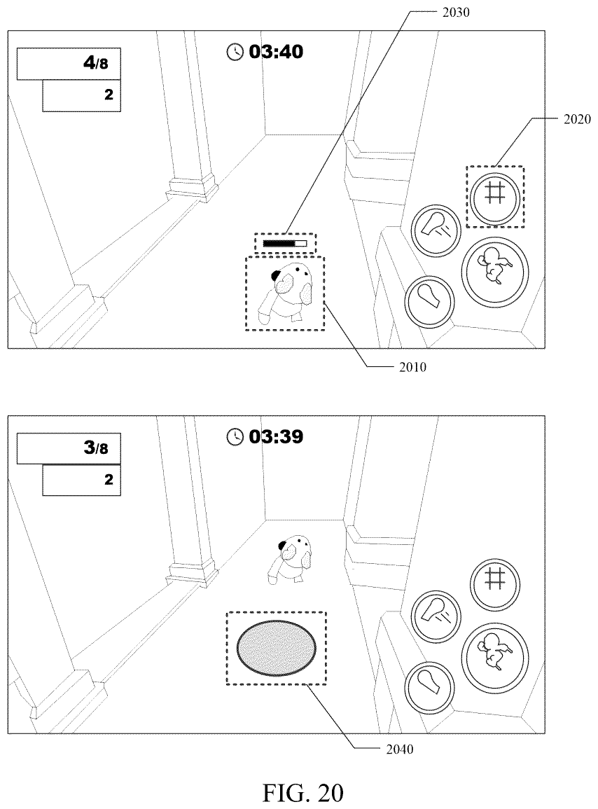

For example, for ease of understanding, FIG. 20 is a schematic diagram of a first virtual object placing a trap prop according to an aspect of this disclosure. As shown in (A) in FIG. 20, 2010 indicates the first virtual object. 2020 indicates a trap control. When a player clicks/taps the trap control indicated by 2020, a trap deployment animation of the first virtual object is played, and a deployment progress bar indicated by 2030 is displayed. When loading of the deployment progress bar is completed, the deployment of a trap is completed. Therefore, an interface shown in (B) in FIG. 20 is displayed. 2040 indicates a placed trap prop. When a proximity distance between a virtual object and the first faction and the trap is less than or equal to a proximity distance threshold in an immobilized state. The deployed trap may be in an invisible state, and the trap is visible to only players having the target identity information. In addition, the duration of the trap may be 40 seconds or other duration. This is not limited herein.

A period of time (for example, 1 second) is required for the virtual object having the target identity information to deploy a trap. Based on this, a player can reasonably deduce that a virtual object that is deploying a trap is a “killer” belonging to the second faction.

Next, in the aspects of this disclosure, a manner of a first virtual object deploys a trap is provided. In the foregoing manner, the virtual object having the target identity information has a trap setting capability. Therefore, the fun of the game can be improved based on traps deployed by players.

In some aspects, based on the foregoing one or more aspects corresponding to FIG. 3, in another aspect provided in the aspects of this disclosure, the identity information of the first virtual object is the first identity information or the second identity information; and
the method may further include:
displaying at least one virtual resource in a virtual scene of the target game application, where virtual resources belonging to the same resource type correspond to the same point value and the same duration value;
controlling the first virtual object to pick up a target virtual resource, where the target virtual resource is one of the at least one virtual resource; and
displaying an accumulated point value of the first virtual object and remaining duration of the target game match according to a resource type to which the target virtual resource belongs.

In one or more aspects, a manner of a virtual object picking up a virtual resource in a virtual scene is described. It can be known from the foregoing aspect that a virtual object (for example, the first virtual object) having the first identity information (for example, the “guard” identity) or the second identity information (for example, the “doll” identity) may pick up a virtual resource in the virtual scene of the target game application.

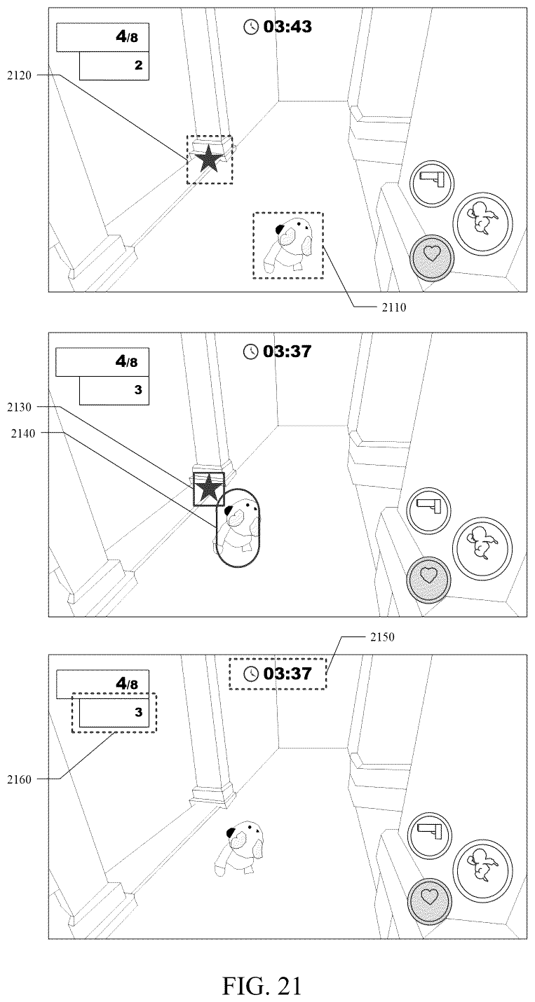

For example, for ease of understanding, FIG. 21 is a schematic diagram of picking up a virtual resource according to an aspect of this disclosure. As shown in (A) in FIG. 21, 2110 indicates the first virtual object, and 2120 indicates a virtual resource. Based on this, a player may control the first virtual object to approach and pick up a virtual resource. Therefore, the virtual resource is the target virtual resource. As shown in (B) in FIG. 21, 2130 indicates a collision box (i.e., a mesh approximately similar to the target virtual resource) that is attached to the target virtual resource and is configured for collision detection. 2140 indicates a collision box (i.e., a capsule-shaped mesh located at the center of the first virtual object) that is attached to the first virtual object and is configured for collision detection.

The collision box of the first virtual object collides with the collision box of the target virtual resource, indicating a picking operation that the first virtual object is controlled to perform on the target virtual resource. Therefore, the first virtual object is triggered to pick up the target virtual resource. Therefore, an interface shown in (C) in FIG. 21 is displayed. 2150 indicates remaining duration of the target game match. For example, the remaining duration is 3 minutes and 37 seconds. 2160 indicates an accumulated point value, for example, 3 points, of the first virtual object. The virtual scene of the target game application includes at least one virtual resource, each virtual resource has a corresponding resource type, and virtual resources belonging to the same resource type correspond to the same point value and the same duration value.

Next, in the aspects of this disclosure, a manner of a virtual object picking up points in a virtual scene is provided. In the foregoing manner, a player from the first faction may search the scene and pick up virtual resources when dodging attacks. On one hand, the player's personal points are increased, and various awards during game settlement are increased. On the other hand, the game time is reduced, which is more beneficial to the winning of the faction to which the player belongs. In this process, the game actions of players from the first faction are also greatly enriched, thereby avoiding monotonous dodging.

In some aspects, based on the foregoing one or more aspects corresponding to FIG. 3, in another aspect provided in the aspects of this disclosure, the displaying an accumulated point value of the first virtual object and remaining duration of the target game match according to a resource type to which the target virtual resource belongs may include:
displaying the accumulated point value of the first virtual object and the remaining duration of the target game match if the resource type of the target virtual resource is a first resource type, where virtual resources belonging to the first resource type correspond to a first point value and the same first duration value, the accumulated point value of the first virtual object is obtained by adding the first point value, and the remaining duration of the target game match is obtained by deducting the first duration value; and
displaying the accumulated point value of the first virtual object and the remaining duration of the target game match if the resource type of the target virtual resource is a second resource type, where virtual resources belonging to the second resource type correspond to a second point value and the same second duration value, the second point value is greater than the first point value, the second duration value is greater than the first duration value, the accumulated point value of the first virtual object is obtained by adding the second point value, and the remaining duration of the target game match is obtained by deducting the second duration value.

In one or more aspects, a manner of providing a corresponding award based on a virtual resource type is described. It can be known from the foregoing aspect that each virtual resource has a corresponding resource type, and virtual resources of different resource types correspond to different point values and duration values.

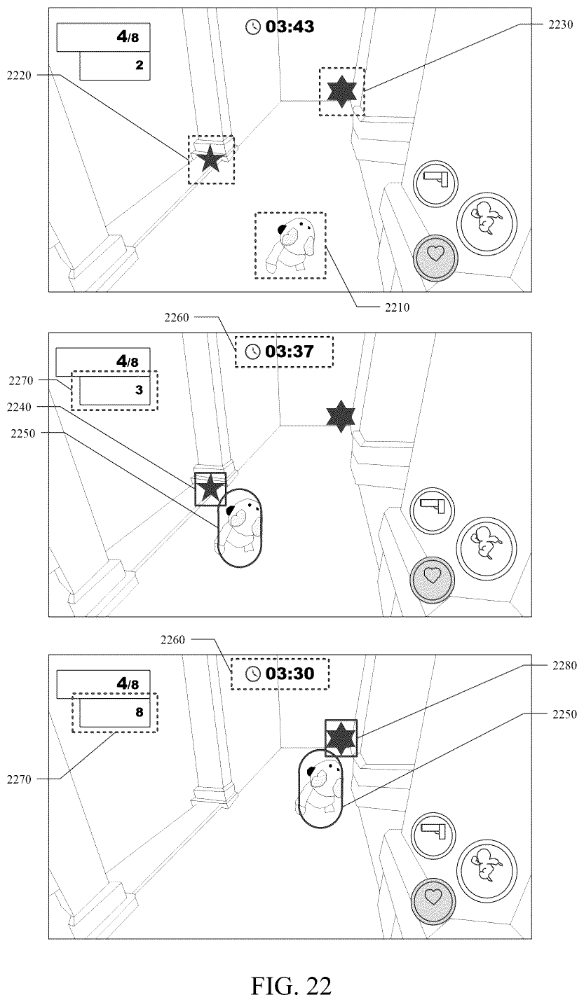

For example, for ease of understanding, FIG. 22 is a schematic diagram of providing a corresponding award based on a resource type according to an aspect of this disclosure. As shown in (A) in FIG. 22, 2210 indicates a first virtual object, 2220 indicates a virtual resource of a first resource type, and 2230 indicates a virtual resource of a second resource type.

For example, in a case, assuming that a player controls the first virtual object to approach and pick up the virtual resource indicated by 2220, the virtual resource is the target virtual resource. Based on this, as shown in (B) in FIG. 22, 2240 indicates a collision box (i.e., a mesh approximately similar to the target virtual resource) that is attached to the target virtual resource and is configured for collision detection. 2250 indicates a collision box (i.e., a capsule-shaped mesh located at the center of the first virtual object) that is attached to the first virtual object and is configured for collision detection. The collision box of the first virtual object collides with the collision box of the target virtual resource indicated by 2240, indicating a picking operation that the first virtual object is controlled to perform on the target virtual resource. Therefore, the first virtual object is triggered to pick up the target virtual resource of the first resource type. It is assumed that the first point value corresponding to the virtual resource of the first resource type is 1 point and the first duration value is 1 second. Therefore, the remaining duration of the target game match indicated by 2260 and an accumulated point value of the first virtual object indicated by 2270 in the figure are displayed. For example, if a virtual object from the first faction picks up the virtual resource corresponding to the first resource type, one point is added to the virtual object, and the remaining duration of the target game match is reduced by one second.

For example, in another case, assuming that a player controls the first virtual object to approach and pick up the virtual resource indicated by 2230, the virtual resource is the target virtual resource. Based on this, as shown in (C) in FIG. 22, 2280 indicates a collision box (i.e., a mesh approximately similar to the target virtual resource) that is attached to the target virtual resource and is configured for collision detection. 2250 indicates a collision box (i.e., a capsule-shaped mesh located at the center of the first virtual object) that is attached to the first virtual object and is configured for collision detection. The collision box of the first virtual object collides with the collision box of the target virtual resource indicated by 2280, indicating a picking operation that the first virtual object is controlled to perform on the target virtual resource. Therefore, the first virtual object is triggered to pick up the target virtual resource of the second resource type. It is assumed that the second point value corresponding to the virtual resource of the second resource type is 5 point and the second duration value is 5 second. Therefore, the remaining duration of the target game match indicated by 2260 and an accumulated point value of the first virtual object indicated by 2270 in the figure are displayed. For example, if a virtual object from the first faction picks up the virtual resource corresponding to the second resource type, five points are added to the virtual object, and the remaining duration of the target game match is reduced by five seconds.

During actual application, the first point value, the second point value, the first duration value, and the second duration value may alternatively be set to be different. However, it needs to be ensured that the second point value is greater than the first point value and the second duration value is greater than the first duration value, to distinguish differences in gain effects brought by different resource types.

Further, in the aspects of this disclosure, a manner of providing a corresponding award based on a virtual resource type is provided. In the foregoing manner, virtual resources are categorized into different types, and different types of virtual resources can bring different game gains. Therefore, the richness and fun of the gameplay can be improved, thereby improving the immersion of the game.

In some aspects, based on the foregoing one or more aspects corresponding to FIG. 3, in another aspect provided in the aspects of this disclosure, the method further includes:
periodically detecting a quantity of virtual resources in the virtual scene of the target game application; and
displaying updated K virtual resources in the virtual scene of the target game application if the quantity of virtual resources is less than a quantity threshold, where K is an integer greater than or equal to 1.

In one or more aspects, a manner of periodically updating virtual resources is described. It can be known from the foregoing aspect that, players belonging to the first faction may control a virtual object to pick up a virtual resource. In a possible solution design, after a player belonging to the second faction picks up a virtual resource, neither a point value is obtained nor the remaining duration of the target game match is reduced. After being picked up, the virtual resource disappears, and the virtual resource is periodically (for example, 20 seconds) randomly spawned at new locations.

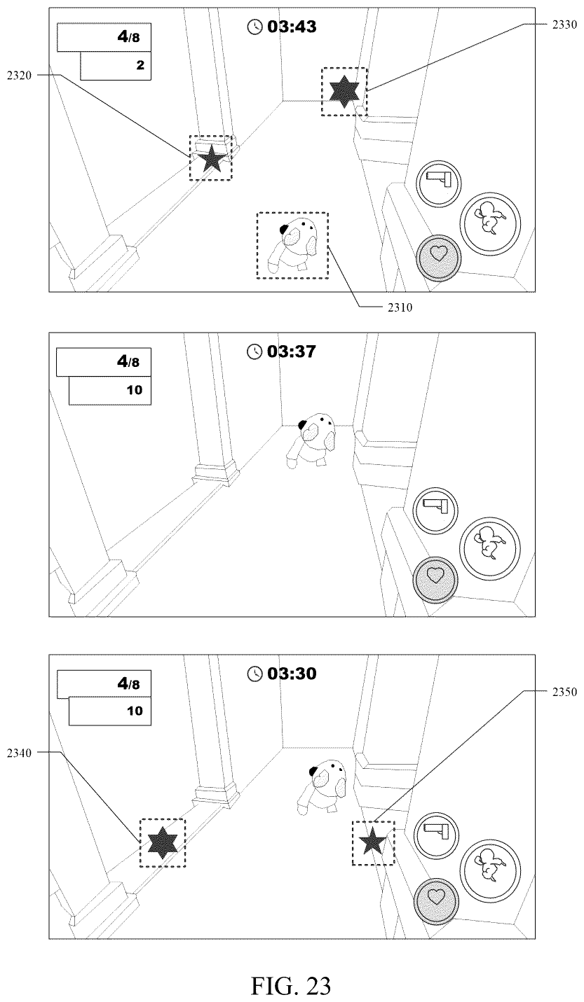

For example, for ease of understanding, FIG. 23 is a schematic diagram of updating a virtual resource in a virtual scene according to an aspect of this disclosure. As shown in (A) in FIG. 23, 2310 indicates a first virtual object, 2320 indicates a virtual resource of a first resource type, and 2330 indicates a virtual resource of a second resource type. It is assumed that a player controls the first virtual object to pick up the virtual resource indicated by 2320 and the virtual resource indicated by 2330. Therefore, an interface shown in (B) in FIG. 23 is displayed. It can be learned that the quantity of virtual resources in the virtual scene is less than the quantity threshold.

It is assumed that the virtual scene of the target game application includes a total of 20 virtual resources. In other words, the quantity threshold is 20. In addition, it is assumed that the quantity of virtual resources is detected once every 20 seconds. If it is determined that the quantity of virtual resources is less than the quantity threshold, virtual resources are randomly spawned at new positions in the virtual scene, and the quantity of virtual resources is increased to the quantity threshold. As shown in (C) in FIG. 23, assuming that only two virtual resources are picked up within a period (for example, 20 seconds), two new virtual resources may be added to the virtual scene. Therefore, updated K virtual resources may be displayed (in this case, K=2). 2340 indicates an updated virtual resource. 2350 indicates another updated virtual resource.

Further, in the aspects of this disclosure, a manner of periodically updating virtual resources is provided. In the foregoing manner, the quantity of virtual resources in the virtual scene may be periodically updated, so that a player can have more chances to collect virtual resources, thereby increasing personal and team gains. Therefore, this is beneficial to increasing the pace of the game and improving the fun of the gameplay.

In some aspects, based on the foregoing one or more aspects corresponding to FIG. 3, in another aspect provided in the aspects of this disclosure, the method further includes:
displaying an aiming line trajectory for a shooting prop when the first virtual object enters a shooting preparation state in a case that the identity information of the first virtual object is the first identity information, where the aiming line trajectory for the shooting prop is a trajectory that extends from a trajectory start point position of the shooting prop to a trajectory end point position and is configured for previewing a shooting path; and
displaying an aiming line trajectory for a throwing prop when the first virtual object enters a throwing preparation state in a case that the identity information of the first virtual object is the target identity information, where the aiming line trajectory for the throwing prop is a trajectory that extends from a trajectory start point position of the throwing prop to a trajectory end point position and is configured for previewing a throwing path, where
the shooting prop and the throwing prop have different appearance designs.

In one or more aspects, a manner of recognizing the identity information of a virtual object is described. It can be known from the foregoing aspect that in a case that virtual objects having specific different identity information are in a non-combat state (i.e., holding no props), the virtual objects are displayed as normal roles. Therefore, the identities of each other cannot be identified through appearances. In a case that virtual objects having specific different identity information are in a combat state (i.e., holding props), the identity information the virtual objects may be determined through the appearance designs of props being held.

For example, if the first virtual object has the first identity information (for example, the “guard” identity), when entering the shooting preparation state, the first virtual object displays the shooting prop held by the first virtual object and the aiming line trajectory for the shooting prop. Because the shooting prop is a prop used during a ranged attack, the first virtual object needs to go through an aiming process before the attack. In the aiming process, the first virtual object holds the shooting prop, so that another player can recognize, by recognizing the shooting prop, that the first virtual object has the first identity information. Correspondingly, when confirming that an opposing player also belongs to the first faction, the first virtual object may perform an aiming action without making no attack, so that the opposing player can recognize that the first virtual object has the first identity information.

For example, if the first virtual object has the target identity information (for example, the “killer” identity), when entering the shooting preparation state, the first virtual object displays the throwing prop held by the first virtual object and the aiming line trajectory for the throwing prop. Because the throwing prop is a prop used during a ranged attack, the first virtual object needs to go through an aiming process before the attack. In the aiming process, the first virtual object holds the throwing prop, so that another player can recognize, by recognizing the shooting prop, that the first virtual object has the target identity information. For the first virtual object having the target identity information, a risk that the identity of the first virtual object is exposed may be reduced by reducing an aiming time.

In this disclosure, the shooting prop and the throwing prop have different appearance designs. Based on this, players can effectively distinguish the identity information of virtual objects holding corresponding props.

Next, in the aspects of this disclosure, a manner of recognizing the identity information of a virtual object is provided. In the foregoing manner, an identity recognition function can be derived by using an aiming process of a virtual object. Based on this, a player having the first identity information may show the identity through an aiming action, thereby establishing the mutual trust between players. Therefore, diversity and richness of the gameplay are improved.

In some aspects, based on the foregoing one or more aspects corresponding to FIG. 3, in another aspect provided in the aspects of this disclosure, a virtual scene of the target game application corresponds to a scene map, the scene map includes M preset initial point positions, and M is an integer greater than or equal to 3; and
after the response to a start operation on a target game match, the method may further include:
displaying a birth point position randomly assigned to the first virtual object, where the birth point position indicates a start position of the first virtual object in the virtual scene of the target game application, and the birth point position is one of the M preset initial point positions.

In one or more aspects, a manner of assigning an initial point position to a virtual object is described. It can be known from the foregoing aspect that, one or more scene maps may be constructed based on the virtual scene of the target game application, and each scene map may include a scene map of at least one layer. A scene map formed by two map layers is used as an example for description below.

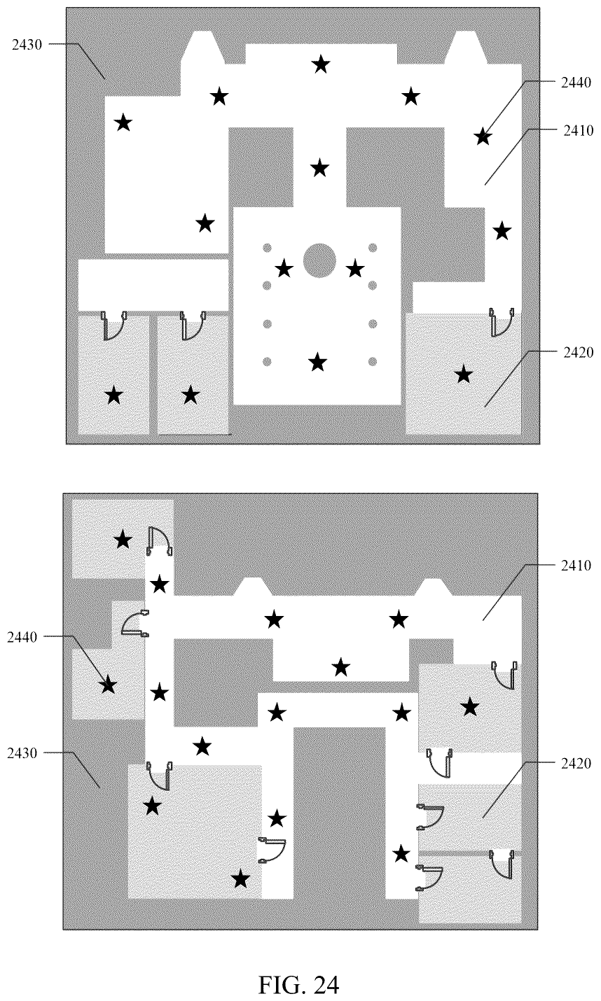

For example, FIG. 24 is a schematic diagram of a scene map constructed based on a virtual scene according to an aspect of this disclosure. For example, (A) in FIG. 24 shows a first map layer, and (B) in FIG. 24 shows a second map layer. The two map layers jointly form the scene map of the virtual scene, and the two map layers may be connected by a staircase. 2410 indicates a passage area. 2420 indicates a room area. 2430 indicates an unpassable area. 2440 indicates a preset initial point position. The first map layer shows 14 preset initial point positions, and the second map layer shows 15 preset initial point positions. In other words, the scene map includes 29 preset initial point positions (in this case, M=29).

After the target game match starts, a birth point position of a virtual object is set in a manner of a preset initial point position. A quantity of preset initial point positions of each game match is greater than or equal to a quantity of birth point positions of players. In addition, even distribution in the virtual scene is ensured as much as possible. A preset initial point position is randomly obtained from the M preset initial point positions as a birth point position for each player according to a matching sequence. For example, a birth point position is randomly assigned to a first virtual object controlled by a player, and the birth point position indicates a start position of the first virtual object in the virtual scene of the target game application.

During actual application, birth point positions require deduplicated randomization. In other words, in one game match, two virtual objects are kept from appearing at one birth point position at the same time.

Next, in the aspects of this disclosure, a technical solution of assigning an initial point position is provided. In the foregoing manner, different virtual objects are randomly assigned to different positions in the virtual scene, so that the randomness and fun of the game are increased, and a sense of novelty is evoked for players, thereby improving the playability of the game.

In some aspects, based on the foregoing one or more aspects corresponding to FIG. 3, in another aspect provided in the aspects of this disclosure, the method further includes:
transmitting, in response to a voice output operation, a voice message to terminals corresponding to P virtual objects, where a scene distance between each of the P virtual objects and the first virtual object is less than or equal to a scene distance threshold, the scene distance indicates a distance in the virtual scene of the target game application, and P is an integer greater than or equal to 1; and
the method may further include:
playing, in response to a voice input operation, voice messages transmitted by terminals corresponding to Q virtual objects, where a scene distance between each of the Q virtual objects and the first virtual object is less than or equal to the scene distance threshold, and Q is an integer greater than or equal to 1.

In one or more aspects, a manner of supporting voice interaction between players is described. It can be known from the foregoing aspect that a player can implement different game functions by using a user operation interface. The user operation interface is a display image, for example, a virtual prop or a virtual object, configured for displaying a virtual environment to a user. In some aspects, the user operation interface further includes some operation controls, for example, buttons, sliders, and icons, for the user to perform operations.

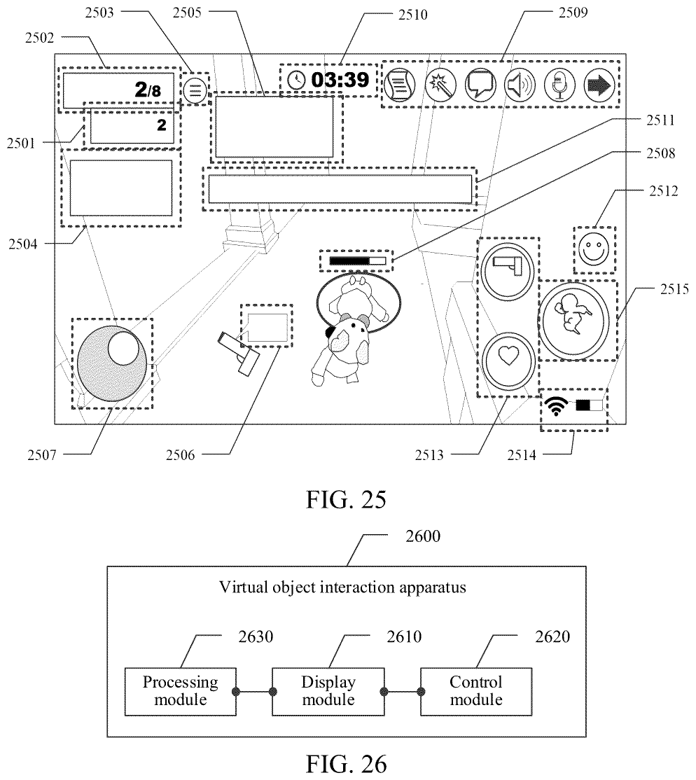

For example, for ease of understanding, FIG. 25 is a schematic diagram of a user operation interface according to an aspect of this disclosure. As shown in the figure, related descriptions are provided below with reference to the figure.

2501 indicates the points of a player, i.e., displays current personal points of the player.

2502 indicates the current quantity of surviving objects of the first faction, i.e., displays the sum of the current quantity of surviving virtual objects having the first identity information and a quantity of virtual objects having the second identity information in the first faction.

2503 indicates an information button. A player information panel may be opened by clicking/taping the information button, and information such as avatars, nicknames, and survival statuses of players in the current game match is displayed on the player information panel.

2504 indicates a nickname of an eliminated player. For example, the prompt may be displayed for three seconds, and then disappear.

2505 indicates a prompt text, i.e., displays a game objective for a player in the current match. Different prompt texts may be displayed for players having different identity information.

2506 indicates a prop prompt icon. For example, a shooting prop that drops in the virtual scene is prompted.

2507 indicates a joystick. For example, a player moves in various directions by operating the joystick.

2508 indicates a rescue progress bar. For example, when a virtual object having the first identity information or the second identity information performs a rescue operation, the rescue progress bar is displayed.

2509 indicates a functional area. The functional area includes six function buttons arranged sequentially from left to right as follows: Rules, Report, Chat, Sound Toggle, Mic Toggle, and Exit Game.

For example, when a player turns on Mic Toggle, a voice message may be transmitted to another player by using a terminal used by the player. It is assumed that the player currently controls a first virtual object. Therefore, another virtual object whose scene distance to the first virtual object is less than or equal to a scene distance threshold is determined according to the virtual scene of the target game application. Assuming that scene distances between a total of P virtual objects and the first virtual object are less than or equal to the scene distance threshold, the voice message is transmitted to P terminals that control the P virtual objects respectively.

For example, when a player turns on Voice Toggle, a voice message transmitted by another player may be received by using a terminal used by the player. It is assumed that the player currently controls a first virtual object. Therefore, another virtual object whose scene distance to the first virtual object is less than or equal to a scene distance threshold is determined according to the virtual scene of the target game application. Assuming that scene distances between a total of Q virtual objects and the first virtual object are less than or equal to the scene distance threshold, voice messages transmitted by Q terminals that control the Q virtual objects respectively may be received.

2510 indicates a countdown timer of the remaining time of the current round of game.

2511 indicates a general prompt. For example, various game information is prompted and described.

2512 indicates an emote wheel. For example, a player sends various in-game emotes via the emote wheel.

2513 indicates a skill control, and a corresponding skill control needs to be displayed according to different identity information. If a player has the first identity information, a shoot control is displayed in a default state, and a rescue control is displayed when the player approaches another player that can be rescued. If a player has the second identity information, no control is displayed in a default state, and a rescue control is displayed when the player approaches another player that can be rescued. If a player has the target identity information, a throw control, an attack control, and a trap control are displayed in a default state.

If a player has the doll identity, no button is provided in a normal state, and when the player approaches a player that can be rescued, a rescue button is displayed. If a player has the guard identity, a shooting button is displayed by default, and when the player approaches a player that can be rescued, a rescue button is displayed. If a player has killer identity, a swinging button, a throwing button, and a trap button are displayed by default.

2514 indicates network status and battery level display.

2515 indicate a jump control. For example, a virtual object may perform a jump once by clicking/taping the jumping button.

Next, in the aspects of this disclosure, a manner of supporting voice interaction between players is provided. In the foregoing manner, if virtual objects are relatively close to each other in the virtual scene of the target game application, players controlling these virtual objects may further perform voice communication. Based on this, on one hand, communication convenience can be improved. On the other hand, voice communication is performed only with a player controlling a nearby virtual object, so that a communication effect of a real scene can be better simulated, thereby improving the realism of the game.

A virtual object interaction apparatus of this disclosure is described below in detail. The virtual object interaction apparatus may be configured in the foregoing computer device. FIG. 26 is a schematic diagram of an aspect of a virtual object interaction apparatus according to an aspect of this disclosure. A virtual object interaction apparatus 30 is used in a target game application including a plurality of virtual objects. The plurality of virtual objects are at least divided into a first faction and a second faction. The first faction includes at least one virtual object having first identity information and at least one virtual object having second identity information. Identity information of each virtual object from the first faction is in a non-public state. The second faction includes at least one virtual object having target identity information. The virtual object interaction apparatus 30 includes:
a display module 2610, configured to display, in response to a start operation on a target game match, identity information randomly assigned to a first virtual object, the identity information being the first identity information, the second identity information, or the target identity information, and the first virtual object being one of the plurality of virtual objects; and
a control module 2620, configured to control the first virtual object to initiate a target interaction event with a second virtual object, the second virtual object being another one of the plurality of virtual objects other than the first virtual object, where
the display module 2610 is further configured to display an interaction event result corresponding to the target interaction event in a case that response to the target interaction event is successful, where the interaction event result has an association relationship with the identity information of the first virtual object and identity information of the second virtual object.

In some aspects, based on the foregoing aspect corresponding to FIG. 26, in another aspect of the virtual object interaction apparatus 30 provided in the aspects of this disclosure, the identity information of the first virtual object is the first identity information or the second identity information, and the identity information of the second virtual object is the first identity information or the second identity information.
the control module 2620 is further configured to control, when the second virtual object is in an immobilized state, the first virtual object to initiate a rescue operation on the second virtual object, and display a first progress bar, where the first progress bar indicates the progress of releasing the immobilized state of the second virtual object; and
the display module 2610 is further configured to determine that the response to the target interaction event is successful in a case that loading of the first progress bar is completed, and display the second virtual object with the immobilized state released.

Based on the foregoing aspect corresponding to FIG. 26, the virtual object interaction apparatus 30 provided in the aspects of this disclosure, the virtual object interaction apparatus further includes a processing module 2630.

The processing module 2630 is configured to reset, after the first progress bar is displayed, a loading progress of the first progress bar if the first virtual object is controlled to end the rescue operation initiated for the second virtual object in a case that the loading of the first progress bar is not completed.

Based on the foregoing aspect corresponding to FIG. 26, in another aspect of the virtual object interaction apparatus 30 provided in the aspects of this disclosure,

The processing module 2630 is configured to pause, after the first progress bar is displayed, a loading progress of the first progress bar if the first virtual object is controlled to end the rescue operation initiated for the second virtual object in a case that loading of the first progress bar is not completed; and
the display module 2610 is further configured to control the first virtual object to display the first progress bar with progress loading continuing for a rescue operation initiated for the second virtual object again.

Based on the foregoing aspect corresponding to FIG. 26, in another aspect of the virtual object interaction apparatus 30 provided in the aspects of this disclosure, the identity information of the first virtual object is the first identity information or the second identity information;
the display module 2610 is further configured to display a second progress bar when the first virtual object is in an immobilized state, where the second progress bar indicates the progress of releasing the immobilized state of the first virtual object; and
the display module 2610 is further configured to display the first virtual object with the immobilized state released in a case that loading of the second progress bar is completed.

Based on the foregoing aspect corresponding to FIG. 26, in another aspect of the virtual object interaction apparatus 30 provided in the aspects of this disclosure, the identity information of the second virtual object is the first identity information or the second identity information;
the display module 2610 is further configured to display, after the second progress bar is displayed, a third progress bar in response to a rescue operation initiated by the second virtual object with the first virtual object, where the third progress bar indicates the progress of releasing the immobilized state of the first virtual object, and duration required for loading of the third progress bar to be completed is less than duration required for the loading of the second progress bar to be completed.

Based on the foregoing aspect corresponding to FIG. 26, in another aspect of the virtual object interaction apparatus 30 provided in the aspects of this disclosure, the identity information of the first virtual object is the first identity information, and the identity information of the second virtual object is the first identity information, the second identity information, or the target identity information;
the control module 2620 is further configured to control the first virtual object to initiate an attack operation on the second virtual object; and
the display module 2610 is further configured to determine that the response to the target interaction event is successful in a case that the second virtual object is hit by the first virtual object, and eliminating the second virtual object from the target game match.

Based on the foregoing aspect corresponding to FIG. 26, in another aspect of the virtual object interaction apparatus 30 provided in the aspects of this disclosure,
the control module 2620 is further configured to: control, in response to a touch operation on a shoot control, the first virtual object to enter a shooting preparation state, and display an aiming line trajectory, where the aiming line trajectory is a trajectory that extends from a trajectory start point position of a shooting prop to a trajectory end point position and is configured for previewing a shooting path; and
determine that the second virtual object is hit by the first virtual object if the aiming line trajectory collides with a collision box of the second virtual object in response to a release operation on the shoot control.

Based on the foregoing aspect corresponding to FIG. 26, in another aspect of the virtual object interaction apparatus 30 provided in the aspects of this disclosure, the display module 2610 is further configured to display, after the second virtual object is eliminated from the target game match, a first match settlement result of the target game match if the identity information of the second virtual object is the target identity information and the second virtual object is the last surviving virtual object from the second faction, where the first match settlement result indicates that the first faction has defeated the second faction.

Based on the foregoing aspect corresponding to FIG. 26, in another aspect of the virtual object interaction apparatus 30 provided in the aspects of this disclosure, the processing module 2630 is further configured to reduce, after the second virtual object is eliminated from the target game match, a current quantity of surviving objects of the first faction if the identity information of the second virtual object is the first identity information or the second identity information.

Based on the foregoing aspect corresponding to FIG. 26, in another aspect of the virtual object interaction apparatus 30 provided in the aspects of this disclosure, the identity information of the first virtual object is the target identity information, and the identity information of the second virtual object is the first identity information or the second identity information;
the control module 2620 is further configured to control the first virtual object to initiate an attack operation on the second virtual object; and
the display module 2610 is further configured to determine that the response to the target interaction event is successful in a case that the second virtual object is hit by the first virtual object, and eliminating the second virtual object from the target game match.

Based on the foregoing aspect corresponding to FIG. 26, in another aspect of the virtual object interaction apparatus 30 provided in the aspects of this disclosure,
the control module 2620 is further configured to: control, in response to a touch operation on a throw control, the first virtual object to enter a throwing preparation state, and display an aiming line trajectory, where the aiming line trajectory is a trajectory that extends from a trajectory start point position of a throwing prop to a trajectory end point position and is configured for previewing a throwing path; and
determine that the second virtual object is hit by the first virtual object if the aiming line trajectory collides with a collision box of the second virtual object in response to a release operation on the throw control.

Based on the foregoing aspect corresponding to FIG. 26, in another aspect of the virtual object interaction apparatus 30 provided in the aspects of this disclosure,
the control module 2620 is further configured to: control the first virtual object to swing an attacking prop in response to a selection operation on an attack control; and
determine that the second virtual object is hit by the first virtual object if the attacking prop collides with a collision box of the second virtual object.

Based on the foregoing aspect corresponding to FIG. 26, in another aspect of the virtual object interaction apparatus 30 provided in the aspects of this disclosure,
the display module 2610 is further configured to display, after the second virtual object is eliminated from the target game match, a second match settlement result, if the identity information of the second virtual object is the first identity information or the second identity information and the second virtual object is the last surviving virtual object from the first faction, where the second match settlement result indicates that the second faction has defeated the first faction;
the display module 2610 is further configured to reduce, after the second virtual object is eliminated from the target game match, a current quantity of surviving objects of the first faction if the identity information of the second virtual object is the first identity information and the first faction still includes at least one surviving virtual object, and display that a shooting prop currently used by the second virtual object drops; and
the display module 2610 is further configured to reduce, after the second virtual object is eliminated from the target game match, the current quantity of surviving objects of the first faction if the identity information of the second virtual object is the second identity information and the first faction still includes at least one surviving virtual object.

Based on the foregoing aspect corresponding to FIG. 26, in another aspect of the virtual object interaction apparatus 30 provided in the aspects of this disclosure, the identity information of the first virtual object is the second identity information;
the display module 2610 is further configured to display a shooting prop in a virtual scene of the target game application, where the shooting prop drops from a virtual object having the first identity information; and
the control module 2620 is further configured to control, in response to a picking operation on the shooting prop, the first virtual object to pick up the shooting prop, and switch the identity information of the first virtual object to the first identity information, where a picking manner of the shooting prop includes picking and using or picking and carrying.

Based on the foregoing aspect corresponding to FIG. 26, in another aspect of the virtual object interaction apparatus 30 provided in the aspects of this disclosure, the identity information of the first virtual object is the target identity information, and the identity information of the second virtual object is the target identity information; and
the display module 2610 is further configured to display a target identity list, where the target identity list includes information about T virtual objects, identity information of each of the T virtual objects is the target identity information, and T is an integer greater than 1;
or,
the display module 2610 is further configured to display the identity information of the second virtual object in a virtual scene of the target game application;
or,
the display module 2610 is further configured to highlight, in the target game match in a virtual scene of the target game application, the second virtual object relative to a virtual object whose identity information is not the target identity information.

Based on the foregoing aspect corresponding to FIG. 26, in another aspect of the virtual object interaction apparatus 30 provided in the aspects of this disclosure, the identity information of the first virtual object is the target identity information;
the processing module 2630 is further configured to play a trap deployment animation of the first virtual object in response to a trap deployment operation; and
the processing module 2630 is further configured to place a trap prop in a virtual scene of the target game application when the playing of the trap deployment animation is completed, where the trap prop is configured for keeping a virtual object from the first faction at a proximity distance from the trap prop being less than or equal to a proximity distance threshold in an immobilized state.

Based on the foregoing aspect corresponding to FIG. 26, in another aspect of the virtual object interaction apparatus 30 provided in the aspects of this disclosure, the identity information of the first virtual object is the first identity information or the second identity information;
the display module 2610 is further configured to display at least one virtual resource in a virtual scene of the target game application, where virtual resources belonging to the same resource type correspond to the same point value and the same duration value;
the control module 2620 is further configured to control the first virtual object to pick up a target virtual resource, where the target virtual resource is one of the at least one virtual resource; and
the display module 2610 is further configured to display an accumulated point value of the first virtual object and remaining duration of the target game match according to a resource type to which the target virtual resource belongs.

Based on the foregoing aspect corresponding to FIG. 26, in another aspect of the virtual object interaction apparatus 30 provided in the aspects of this disclosure,
the display module 2610 is further configured to: display the accumulated point value of the first virtual object and the remaining duration of the target game match if the resource type of the target virtual resource is a first resource type, where virtual resources belonging to the first resource type correspond to a first point value and the same first duration value, the accumulated point value of the first virtual object is obtained by adding the first point value, and the remaining duration of the target game match is obtained by deducting the first duration value; and
display an accumulated point value of a first virtual object and remaining duration of a target game match if a resource type of the target virtual resource is a second resource type, virtual resources belonging to the second resource type corresponding to a second point value and the same second duration value, the second point value being greater than the first point value, the second duration value being greater than the first duration value, the accumulated point value of the first virtual object being obtained after the second point value is added, and the remaining duration of the target game match being obtained after the second duration value is deducted.

Based on the foregoing aspect corresponding to FIG. 26, in another aspect of the virtual object interaction apparatus 30 provided in the aspects of this disclosure,
the processing module 2630 is further configured to periodically detect a quantity of virtual resources in the virtual scene of the target game application; and
the display module 2610 is further configured to display updated K virtual resources in the virtual scene of the target game application if the quantity of virtual resources is less than a quantity threshold, where K is an integer greater than or equal to 1.

Based on the foregoing aspect corresponding to FIG. 26, in another aspect of the virtual object interaction apparatus 30 provided in the aspects of this disclosure,
the display module 2610 is further configured to display an aiming line trajectory for a shooting prop when the first virtual object enters a shooting preparation state in a case that the identity information of the first virtual object is the first identity information, where the aiming line trajectory for the shooting prop is a trajectory that extends from a trajectory start point position of the shooting prop to a trajectory end point position and is configured for previewing a shooting path; and
the display module 2610 is further configured to display an aiming line trajectory for a throwing prop when the first virtual object enters a throwing preparation state in a case that the identity information of the first virtual object is the target identity information, where the aiming line trajectory for the throwing prop is a trajectory that extends from a trajectory start point position of the throwing prop to a trajectory end point position and is configured for previewing a throwing path, where
the shooting prop and the throwing prop have different appearance designs.

Based on the foregoing aspect corresponding to FIG. 26, in another aspect of the virtual object interaction apparatus 30 provided in the aspects of this disclosure, a virtual scene of the target game application corresponds to a scene map, the scene map includes M preset initial point positions, and M is an integer greater than or equal to 3; and
the display module 2610 is further configured to display, after the response to a start operation on a target game match, a birth point position randomly assigned to the first virtual object, where the birth point position indicates a start position of the first virtual object in the virtual scene of the target game application, and the birth point position is one of the M preset initial point positions.

In some aspects, based on the foregoing aspect corresponding to FIG. 26, in another aspect of the virtual object interaction apparatus 30 provided in the aspects of this disclosure,
the processing module 2630 is further configured to send, in response to a voice output operation, a voice message to terminals corresponding to P virtual objects, where a scene distance between each of the P virtual objects and the first virtual object is less than or equal to a scene distance threshold, the scene distance indicates a distance in the virtual scene of the target game application, and P is an integer greater than or equal to 1; and
the processing module 2630 is further configured to play, in response to a voice input operation, voice messages transmitted by terminals corresponding to Q virtual objects, where a scene distance between each of the Q virtual objects and the first virtual object is less than or equal to the scene distance threshold, and Q is an integer greater than or equal to 1.

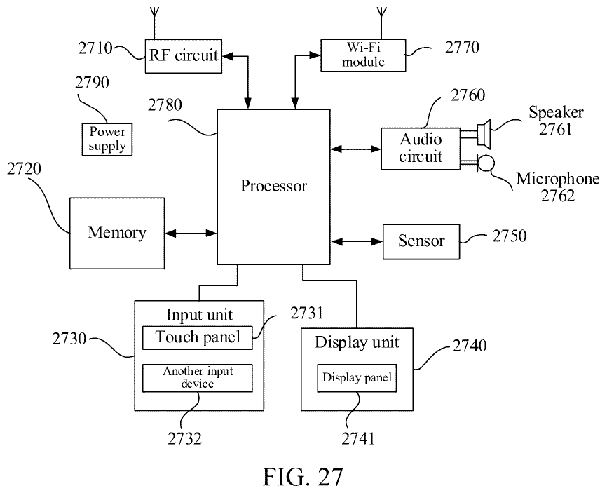

Aspects of this disclosure further provide a computer device. The computer device may be a terminal or a server. An example in which the computer device is a terminal is used for description below. As shown in FIG. 27, for ease of description, only a part related to the aspects of this disclosure is shown. For an example of technical details that are not disclosed, reference can be made to the method part of the aspects of this disclosure. In this aspect of this disclosure, an example in which the terminal is a mobile phone is used for description.

FIG. 27 is a block diagram of a part of a structure of the mobile phone related to the terminal provided in this aspect of this disclosure. Referring to FIG. 27, the mobile phone includes: components such as a radio frequency (RF) circuit 2710, a memory 2720 (for example, a non-transitory computer-readable storage medium), an input unit 2730, a display unit 2740, a sensor 2750, an audio circuit 2760, a Wi-Fi module 2770, a processor 2780 (for example, processing circuitry), and a power supply 2790. It is noted that the structure of the mobile phone shown in FIG. 27 does not constitute a limitation on the mobile phone, and the mobile phone may include more or fewer components than those shown in the figure, or some components may be combined, or a different component deployment may be used.

The following describes the components of the mobile phone with reference to FIG. 27.

The RF circuit 2710 may be configured to receive and transmit signals during an information receiving and transmitting process or a call process. For example, the RF circuit receives downlink information from a base station, then delivers the downlink information to the processor 2780 for processing, In addition, the RF circuit transmits uplink data to the base station.

The memory 2720 may be configured to store a software program and a module. The processor 2780 runs the software program and the module stored in the memory 2720, to implement various functional applications and data processing of the mobile phone.

The input unit 2730 may be configured to receive inputted digit or character information, and generate a key signal input related to user settings and function control of the mobile phone.

The display unit 2740 may be configured to display information inputted by the user or information provided for the user, and various menus of the mobile phone. The display unit 2740 may include a display panel 2741.

The mobile phone may further include at least one sensor 2750 such as an optical sensor, a motion sensor, and other sensors.

The audio circuit 2760, a speaker 2761, and a microphone 2762 may provide audio interfaces between the user and the mobile phone.

The processor 2780 is a control center of the mobile phone, and is connected to various parts of an entire mobile phone by using various interfaces and lines. By running or executing the software program and/or the module stored in the memory 2720, and invoking data stored in the memory 2720, the processor executes various functions of the mobile phone and performs data processing.

Although not shown in the figure, the mobile phone may further include a camera, a Bluetooth module, and the like, which are not described in detail herein.

Operations performed by the terminal in the foregoing aspect may be based on a structure of the terminal that is shown in FIG. 27.

Aspects of this disclosure further provide a computer-readable storage medium, such as a non-transitory computer-readable storage medium, having a computer program stored therein, and the computer program, when executed by a processor, implements the operations of the method described in the foregoing aspects.

Aspects of this disclosure further provide a computer program product, including a computer program. When the computer program is executed by a processor, the operations of the methods described in the foregoing aspects are implemented.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

It is noted that for convenience and conciseness of description, for specific working processes of the foregoing systems, devices and units, refer to the corresponding processes in the foregoing method aspects, and details are not described herein again.

In the several aspects provided in this disclosure, the disclosed system, apparatus, and method may be implemented in other manners. For example, the described apparatus aspect is merely an example. For example, the unit division is merely a logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate components may or may not be physically separated, and the components displayed as units may or may not be physical units, and may be located in one place or may be distributed over a plurality of network units. Some or all of the units may be selected according to actual needs to achieve the objectives of the solutions of the aspects.

In addition, functional units in the aspects of this disclosure may be integrated into one processing unit, or each of the units may be physically separated, or two or more units may be integrated into one unit. The integrated unit may be implemented in the form of hardware, or may be implemented in a form of a software functional unit.

When the integrated unit is implemented in the form of a software functional unit and sold or used as an independent product, the integrated unit may be stored in a computer-readable storage medium, such as a non-transitory computer-readable storage medium. Based on such an understanding, the technical solutions of this disclosure essentially, or the part contributing to the related technology, or all or some of the technical solutions may be implemented in the form of a software product. The computer software product is stored in a storage medium and includes several instructions for instructing a computer device (which may be a server, a terminal device, or the like) to perform all or some of the steps of the methods described in the aspects of this disclosure. The foregoing storage medium includes: various media that may store a computer program, for example, a USB flash disk, a mobile hard disk, a read-only memory (ROM), a random access memory (RAM), a magnetic disk, or an optical disc.

Based on the above, the foregoing aspects are merely intended to describe examples of the technical solutions of this disclosure, and are not intended to limit this disclosure. Although this disclosure is described with reference to the foregoing aspects, It is noted that modifications may still be made to the technical solutions described in the foregoing aspects, or equivalent replacements may be made to the part of the technical features; provided that such modifications or replacements do not cause the essence of corresponding technical solutions to depart from the spirit and scope of the technical solutions of the aspects of this disclosure.

What is claimed is:

1. A virtual object interaction method for a game application, the method comprising:
outputting for display, in response to starting a target game match, identity information assigned to a first virtual object of a plurality of virtual objects in the target game match, the first virtual object being controlled by a player, each of the plurality of virtual objects being divided into one of a first faction and a second faction, the first faction including a first subset of the plurality of virtual objects having first identity information and a second subset of the plurality of virtual objects having second identity information, the second faction including a third subset of the plurality of virtual objects having third identity information;
controlling the first virtual object to initiate an interaction with a second virtual object of the plurality of virtual objects; and
outputting for display an interaction result that is based on the interaction, the identity information of the first virtual object, and the identity information of the second virtual object.

2. The method according to claim 1, wherein
the identity information of the first virtual object is the first identity information or the second identity information, and the identity information of the second virtual object is the first identity information or the second identity information;
the controlling the first virtual object comprises:
controlling, when the second virtual object is in an immobilized state, the first virtual object to initiate a rescue operation on the second virtual object; and
outputting for display a rescue progress indicator that indicates the progress of releasing the immobilized state of the second virtual object; and
the outputting for display the interaction result includes outputting for display the second virtual object with the immobilized state released upon completion of the rescue operation.

3. The method according to claim 2, further comprising:
outputting for display an auto release progress indicator when the first virtual object is in the immobilized state, the auto release progress indicator indicating the progress of automatically releasing the immobilized state of the first virtual object; and
outputting for display the first virtual object with the immobilized state released when loading of the auto release progress indicator is completed.

4. The method according to claim 3, wherein
the identity information of the second virtual object is the first identity information or the second identity information; and
the method further comprises:
outputting for display an assisted rescue progress indicator based on the rescue operation initiated by the second virtual object for the first virtual object, the assisted rescue progress indicator indicating the progress of releasing the immobilized state of the first virtual object, a duration required for completing the assisted rescue progress indicator being less than a duration required for completing the auto release progress indicator.

5. The method according to claim 1, wherein
the identity information of the first virtual object is the first identity information,
the identity information of the second virtual object is the first identity information, the second identity information, or the third identity information; and
the controlling the first virtual object comprises:
controlling the first virtual object to initiate an attack on the second virtual object; and
eliminating the second virtual object from the target game match when the second virtual object is hit by the first virtual object based on the attack.

6. The method according to claim 5, wherein the controlling the first virtual object to initiate the attack on the second virtual object comprises:
controlling, based on a touch operation on a shooting control element, the first virtual object to enter a shooting preparation state;
outputting for display an aiming line trajectory extending from a trajectory start position of a shooting prop to a trajectory end position for previewing a shooting path; and
determining that the second virtual object is hit by the first virtual object when the aiming line trajectory collides with a collision box of the second virtual object based on a release operation on the shooting control element.

7. The method according to claim 5, further comprising:
outputting for display a first match settlement result of the target game match when the identity information of the second virtual object is the third identity information and the second virtual object is a last surviving virtual object from the second faction, wherein
the first match settlement result indicates that the first faction has defeated the second faction.

8. The method according to claim 1, wherein
the identity information of the first virtual object is the third identity information,
the identity information of the second virtual object is the first identity information or the second identity information; and
the controlling the first virtual object comprises:
controlling the first virtual object to initiate an attack on the second virtual object;
eliminating the second virtual object from the target game match when the second virtual object is hit by the first virtual object based on the attack.

9. The method according to claim 8, wherein the controlling the first virtual object to initiate the attack on the second virtual object comprises:
controlling, based on a touch operation on a throw control element, the first virtual object to enter a throwing preparation state;
outputting for display an aiming line trajectory extending from a trajectory start position of a throwing prop to a trajectory end position for previewing a throwing path; and
determining that the second virtual object is hit by the first virtual object when the aiming line trajectory collides with a collision box of the second virtual object based on a release operation on the throw control element.

10. The method according to claim 8, wherein the controlling the first virtual object to initiate the attack on the second virtual object comprises:
controlling the first virtual object to swing a melee attacking prop based on a selection operation on an attack control element; and
determining that the second virtual object is hit by the first virtual object when a collision box of the melee attacking prop collides with a collision box of the second virtual object.

11. The method according to claim 8, further comprising:
outputting for display a second match settlement result when the identity information of the second virtual object is the first identity information or the second identity information and the second virtual object is a last surviving virtual object from the first faction, wherein the second match settlement result indicates that the second faction has defeated the first faction;
reducing a current quantity of surviving objects of the first faction when the identity information of the second virtual object is the first identity information and the first faction includes at least one surviving virtual object;
outputting for display that a shooting prop held by the second virtual object is dropped; and
reducing the current quantity of surviving objects of the first faction when the identity information of the second virtual object is the second identity information and the first faction includes at least one surviving virtual object.

12. The method according to claim 1, wherein
the identity information of the first virtual object is the second identity information; and
the method further comprises:
outputting for display a shooting prop in a virtual scene of the game application, the shooting prop being dropped from one of the plurality of virtual objects having the first identity information; and
controlling, based on a pick operation on the shooting prop, the first virtual object to pick up the shooting prop, and switch the identity information of the first virtual object to the first identity information.

13. The method according to claim 1, wherein
the identity information of the first virtual object is the third identity information, and
the method further comprises performing at least one of:
outputting for display a list including information about T virtual objects of the plurality of virtual objects, each of the T virtual objects having the third identity information, T being an integer greater than 1;
outputting for display identity information of another virtual object of the plurality of virtual objects having the third identity information in a virtual scene of the game application; or
highlighting a virtual object of the plurality of virtual objects having the third identity information relative to other virtual objects of the plurality of virtual objects in the target game match.

14. The method according to claim 1, wherein
the identity information of the first virtual object is the third identity information; and
the method further comprises:
playing a trap deployment animation of the first virtual object based on a trap deployment operation; and
immobilizing a virtual object of the plurality of virtual objects from the first faction when the virtual object is within a distance threshold of a trap prop placed by the first virtual object.

15. The method according to claim 1, wherein
the identity information of the first virtual object is the first identity information or the second identity information; and
the method further comprises:
outputting for display at least one virtual resource in a virtual scene of the game application, virtual resources of a same resource type corresponding to a same point value and a same duration value;
controlling the first virtual object to pick up a target virtual resource of the at least one virtual resource; and
outputting for display an accumulated point value of the first virtual object and a remaining duration of the target game match based on the resource type of the target virtual resource.

16. The method according to claim 15, wherein the outputting for display the accumulated point value of the first virtual object comprises:
outputting for display the accumulated point value and the remaining duration when the target virtual resource is of a first resource type corresponding to a first point value and a first duration value; and
outputting for display the accumulated point value and the remaining duration when the target virtual resource is of a second resource type corresponding to a second point value greater than the first point value and a second duration value greater than the first duration value.

17. The method according to claim 1, further comprising:
outputting for display an aiming line trajectory for a shooting prop when the first virtual object enters a shooting preparation state when the identity information of the first virtual object is the first identity information; and
outputting for display an aiming line trajectory for a throwing prop when the first virtual object enters a throwing preparation state when the identity information of the first virtual object is the third identity information, wherein
the shooting prop and the throwing prop have different appearances.

18. The method according to claim 1, wherein
a virtual scene of the game application corresponds to a virtual environment including M initial point positions for the plurality of virtual objects, M being an integer greater than or equal to 3; and
the method further comprises:
outputting for display a spawn position assigned to the first virtual object, the spawn position indicating a start position of the first virtual object in the virtual scene of the game application, the spawn position being one of the M initial point positions.

19. A virtual object interaction apparatus for a game application, the apparatus comprising:
processing circuitry configured to:
output for display, in response to starting a target game match, identity information assigned to a first virtual object of a plurality of virtual objects in the target game match, the first virtual object being controlled by a player, each of the plurality of virtual objects being divided into one of a first faction and a second faction, the first faction including a first subset of the plurality of virtual objects having first identity information and a second subset of the plurality of virtual objects having second identity information, the second faction including a third subset of the plurality of virtual objects having third identity information;
control the first virtual object to initiate an interaction with a second virtual object of the plurality of virtual objects; and
output for display an interaction result that is based on the interaction, the identity information of the first virtual object, and the identity information of the second virtual object.

20. A non-transitory computer-readable storage medium storing instructions which, when executed by a processor, cause the processor to perform:
outputting for display, in response to starting a target game match, identity information assigned to a first virtual object of a plurality of virtual objects in the target game match, the first virtual object being controlled by a player, each of the plurality of virtual objects being divided into one of a first faction and a second faction, the first faction including a first subset of the plurality of virtual objects having first identity information and a second subset of the plurality of virtual objects having second identity information, the second faction including a third subset of the plurality of virtual objects having third identity information;
controlling the first virtual object to initiate an interaction with a second virtual object of the plurality of virtual objects; and
outputting for display an interaction result that is based on the interaction, the identity information of the first virtual object, and the identity information of the second virtual object.
